(19) United States
(12) Patent Application Publication
(10) Pub. No.: US 2026/0034528 A1
(43) Pub. Date: Feb. 5, 2026

(54) Methods for Regulating Reactor Catalyst Flow Distribution During Olefin Polymerization

(71) Applicant: ExxonMobil Technology and Engineering Company, Spring, TX (US)

(72) Inventors: Jason R. Fischer, Houston, TX (US); Xuan Ye, Houston, TX (US); Sebastian Chialvo, Spring, TX (US); Adriana S. Silva, Houston, TX (US); Kevin A. Stevens, Somerville, NJ (US); Ryan W. Impelman, Houston, TX (US); Richard E. Pequeno, Baytown, TX (US)

(21) Appl. No.: 19/150,038

(22) PCT Filed: Mar. 7, 2024
(86) PCT No.: PCT/US2024/018778

§ 371 Date: Jul. 22, 2025

Related U.S. Application Data
(60) Provisional application No. 63/489,960, filed on Mar. 13, 2023.

(51) Int. Cl. B01J 8/08; B01J 4/00; B01J 37/04; C08F 10/00

(52) U.S. Cl. CPC B01J 8/082; B01J 4/002; B01J 8/085; B01J 8/087; B01J 37/04; C08F 10/00; B01J 2204/002; B01J 2208/00557; B01J 2208/00752; C08F 2400/02

(57) ABSTRACT

Slurry flow valves may be used to control flow in a gas-phase polymerization reactor. For example, a system may include at least three injection nozzles fluidly connected to a gas-phase polymerization reactor, wherein the at least three injection nozzles are configured to carry' a modified catalyst slurry; at least three lines connected to the at least three injection nozzles, wherein the at least-three lines comprise a first line connected to a first injection nozzle, a second line connected to a second injection nozzle, and a third line connected to a third injection nozzle; and at least three slurry? flow valves in contact with the at least three lines, wherein the at least three slurry flow valves comprise a first slurry flow valve, a second slurry flow valve, and a third slurry' flow valve. Preferably, the valves can each be independently controlled to regulate flow therethrough.

### CROSS-REFERENCE TO RELATED APPLICATIONS

This application claims the benefit of U.S. Provisional Application 63/489,960 filed Mar. 13, 2023 entitled “Methods for Modifying a Supported Catalyst During Olefin Polymerization”, the entirety of which is incorporated by reference herein.

### FIELD

The present disclosure relates to methods for polymerizing one or more olefins, and more particularly, methods for polymerizing one or more olefins by regulating flow distribution of slurry catalyst feed.

### BACKGROUND

Gas-phase polymerization is useful for polymerizing ethylene or ethylene and one or more olefin co-monomers. Gas-phase polymerization processes conducted in fluidized beds are particularly economical. One or more olefin monomers and catalyst particles containing an activated catalyst compound can be introduced into a polymerization reactor, in which the olefin monomer(s) can polymerize in the presence of the catalyst particles to produce a polyolefin product, preferably in fine particle form.

During polymerization, the catalyst particles (i.e., a supported catalyst) can begin to overheat, especially when a catalyst compound upon the catalyst particles has an aggressive kinetic profile. When the catalyst particles overheat, the polymer particles within the reactor can begin to stick together, which can lead to the eventual buildup of polymer within the reactor. The buildup of polymer within the reactor, which is usually referred to as agglomeration, chunking, or sheeting, can lead to process upsets and even reactor shutdown in some cases The term sheeting is used herein. Moreover, thermal swings during gas-phase polymerization can alter the viscosity of fluids, resulting in flow rate alterations, equipment (e.g., injection nozzle) plugging, and increased back pressure in the system resulting in sub-optimal catalyst activation and challenges with process control, including sheeting of the resulting polymer.

One way in which overheating of the catalyst particles can be tempered is by changing the ratio of catalyst compound(s) upon the catalyst particles, which is typically performed by control of fluid flows involved in polymerization. For maximum process flexibility, modification of the catalyst particles may take place in situ during delivery to a polymerization reaction without process shutdown taking place. In some examples, a catalyst solution may be contacted with the catalyst particles to introduce additional catalyst compound onto the catalyst particles and/or to introduce a different catalyst compound onto the catalyst particles. The catalyst solution introducing the additional catalyst compound and/or the different catalyst compound to the catalyst particles may be referred to as a “trim catalyst” or “trim catalyst solution,” since the catalyst solution modulates the performance of the original catalyst particles.

Unfortunately, modification of catalyst particles in situ in the foregoing manner may lead to the aforementioned sub-optimal catalyst activation and challenges with process control. Indeed, typically process flow control in chemical plants utilizes control valves. However, due to the presence of solids in fluids utilized for gas-phase polymerization (e.g., solid catalyst particles), control valves can erode or result in stagnant flow zones in which the valves can plug due to undesired solids settling, and thus result in continued adverse influence on product quality and reactor operability.

Some references of potential interest in this area include: U.S. Pat. No. 10,927,205; US Pat. Pub. Nos. US2022/0056168, US2021/0121847, US2022/0033536 and US2022/0033537; and International Pat. Pub. No WO2022/174202.

Thus, there remains a need for improved processes for polymerizing one or more olefin monomers during gas-phase polymerization to reduce or eliminate thermal fluctuations within a reactor.

### SUMMARY

The present disclosure relates to methods for polymerizing one or more olefins, and more particularly, methods for polymerizing one or more olefins by regulating flow distribution to control slurry catalyst temperature.

These and other features and attributes of the disclosed methods of the present disclosure and their advantageous applications and/or uses will be apparent from the detailed description which follows.

A nonlimiting system of the present disclosure includes: at least three injection nozzles fluidly connected to a gas-phase polymerization reactor, wherein the at least three injection nozzles are configured to carry a modified catalyst slurry; at least three lines connected to the at least three injection nozzles, wherein the at least three lines comprise a first line connected to a first injection nozzle, a second line connected to a second injection nozzle, and a third line connected to a third injection nozzle; and at least three slurry flow valves in contact with the at least three lines, wherein the at least three slurry flow valves comprise a first slurry flow valve, a second slurry flow valve, and a third slurry flow valve.

A nonlimiting flow control method of the present disclosure includes: flowing a modified catalyst slurry into a gas-phase polymerization reactor through at least a first line connected to a first injection nozzle, a second line connected to a second injection nozzle, and a third line connected to a third injection nozzle, wherein each of the first, second, and third injection nozzles are in fluid communication with the gas-phase polymerization reactor; and independently regulating each of: a) a first flow rate of modified catalyst slurry of the first line by at least partially opening or closing a first slurry flow valve in contact with the first line, b) a second flow rate of modified catalyst slurry of the second line by at least partially opening or closing a second slurry flow valve in contact with the second line, or c) a third flow rate of modified catalyst slurry of the third line by at least partially opening or closing a third slurry flow valve in contact with the third line.

Another nonlimiting method of the present disclosure includes: obtaining a catalyst slurry comprising a supported catalyst, the supported catalyst comprising a support material, at least a first catalyst compound, and at least one activator; obtaining a catalyst solution comprising the first catalyst compound or a second catalyst compound different from the first catalyst compound and not already contained upon the supported catalyst; contacting the catalyst slurry with the catalyst solution in a mixing unit to obtain a modified catalyst slurry from the mixing unit, the modified catalyst slurry comprising a modified supported catalyst incorporating at least a portion of the first catalyst compound or the second catalyst compound from the catalyst solution; flowing the modified catalyst slurry into a gas-phase polymerization reactor through at least a first line connected to a first injection nozzle, a second line connected to a second injection nozzle, and a third line connected to a third injection nozzle, wherein each of the first, second, and third injection nozzles are in fluid communication with a gas-phase polymerization reactor; and independently regulating each of one or more of: a) a first flow rate of modified catalyst slurry of the first line by at least partially opening or closing a first slurry flow valve in contact with the first line, b) a second flow rate of modified catalyst slurry of the second line by at least partially opening or closing a second slurry flow valve in contact with the second line, or c) a third flow rate of modified catalyst slurry of the third line by at least partially opening or closing a third slurry flow valve in contact with the third line.

### BRIEF DESCRIPTION OF THE DRAWINGS

To assist those of ordinary skill in the relevant art in making and using the subject matter

hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a block diagram schematic of a gas-phase reactor system, in which flow rates of individual lines may be regulated by heating block(s).

FIG. 2 is a block diagram schematic of a gas-phase reactor system, in which flow rates of individual lines may be regulated by slurry flow valve(s).

FIG. 3 is a block diagram schematic of a gas-phase reactor system, in which in which flow rates of individual lines are regulated by slurry flow valve(s) and heating block(s).

FIG. 4 is a graph of viscosity measured at various sampling points at varying temperatures, according to one or more aspects of the present disclosure.

### DETAILED DESCRIPTION

The present disclosure relates to methods for polymerizing one or more olefins, and more particularly, methods for polymerizing one or more olefins by regulating flow distribution to control slurry catalyst temperature.

As discussed above, catalyst particles (i.e., a supported catalyst) may be modified in situ prior to conducting a polymerization reaction, such as to mitigate polymer sheeting. However, in situ modification of catalyst particles may lead to ineffective catalyst activation and continued difficulties with a polymerization process and polymerization equipment. The foregoing difficulties may be addressed through the disclosure herein.

### Definitions

Various specific embodiments, versions, and examples of the aspects of the present disclosure will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements, or limitations that are equivalent to those that are recited. Any reference to the “invention” may refer to one or more, but not necessarily all, of the inventions defined by the claims.

As used herein, the indefinite article “a” or “an” shall mean “at least one” unless specified to the contrary or the context clearly indicates otherwise. Thus, embodiments using “an alpha-olefin” include embodiments where one, two, or more alpha-olefins are used, unless specified to the contrary or the context clearly indicates that only one alpha-olefin is used.

Unless otherwise indicated, all numbers indicating quantities in this disclosure are to be understood as being modified by the term “about” in all instances. It should also be understood that the precise numerical values used in the specification and claims constitute specific embodiments.

The term “and/or” as used in a phrase such as “A and/or B” herein is intended to include “A and B,” “A or B,” “A,” and “B.”

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

For the purposes of this disclosure, the nomenclature of elements is pursuant to the NEW NOTATION version of the Periodic Table of Elements as provided in Hawley's Condensed Chemical Dictionary, 16^{th} Ed., John Wiley & Sons, Inc., (2016), Appendix V unless otherwise noted

As used herein, the terms “optional” or “optionally” mean that the subsequently described event or circumstance does or does not occur (or an element is or is not present) and that the description includes instances where said event or circumstance occurs and instances where said event or circumstance does not occur.

A “reactor” is any type of vessel or containment device in any configuration of one or more reactors, and/or one or more reaction zones, wherein a similar polymer is produced. The term “gas-phase polymerization” refers to the production of polymer in a gas-phase reactor (referred to herein simply as a “reactor”). It should also be noted that when a “gas-phase” polymerization or reactor is referenced, it is contemplated that monomers are typically reacted in a gas phase in a reaction zone; however, the monomers need not necessarily be supplied to the reactor in a gas phase. Rather, the monomers may be supplied in a gas phase, liquid phase (condensed phase), or a hybrid gas-liquid phase. Accordingly, when gaseous monomeric streams or cycle gas streams are referenced herein as part of a gas-phase polymerization reactor system or process, it should be understood that such gas streams can in fact be at least partially condensed (that is, in a gas-liquid hybrid phase). In other words, any stream referenced as a gas stream, recirculated gas, or the like, in the context of a gas-phase reaction system as described herein, can be considered to optionally be at least partially liquefied, as is known in the art. See discussion of so-called “condensed mode” of operating certain gas-phase polymerization reactors, e.g., in Namkajorn et al., Condensed Mode Cooling for Ethylene Polymerization: Part III. The Impact of Induced Condensing Agents on Particle Morphology and Polymer Properties, J. MACROMOL. CHEM. AND PHYS. 217, 1521-1528 (Wiley 2016), where it is noted that in some fluidized bed gas-phase polymerization reactors, recycle stream or cycle gas can be cooled to a temperature below its dew point so that it is partially liquified, and then fed into the bottom of the fluidized bed reactor, where latent heat of vaporization of the liquid in the feed absorbs the heat of polymerization and thereby offers increased cooling and the potential for increased reaction rates.

The term “injection nozzle” means a conduit, such as a sprayer, through which a fluid may flow and is herein connected to a line (e.g., pipe, tube, etc.). The injection nozzle(s) of the present disclosure may be in fluid communication with one or more polymerization reactors.

As used herein, the term “fluid” refers to a liquid or gas, typically a liquid according to the present disclosure, which may comprise one or more solids entrained therein or, alternatively, no solids.

The term “slurry catalyst” refers to a contact product comprising a dispersed supported catalyst that includes at least one catalyst compound upon a support, a carrier liquid, and an activator, and an optional co-activator. In particular embodiments, the slurry catalyst may include two catalyst compounds, such as two metallocene catalyst compounds, particularly after formation of a modified catalyst slurry. For instance, the modified slurry catalyst may include a supported catalyst comprising a first metallocene and a second metallocene that are different from the other in at least one structural aspect. Additional disclosure on suitable catalyst compounds is provided further below.

“Alkoxides” include an oxygen atom bonded to an alkyl group that is a C₁ to C₁₀ hydrocarbyl. The alkyl group may be straight chain, branched, or cyclic. The alkyl group may be saturated or unsaturated. In at least one embodiment, the alkyl group may comprise at least one aromatic group.

The terms “anti-static agent,” “continuity additive,” “continuity aid,” and “antifoulant agent” are interchangeable and refer to compounds or mixtures of compounds, such as solids and/or liquids that are useful during polymerization to reduce fouling of a reactor. Fouling of the reactor may be caused by polymer buildup within the reactor. Fouling of the reactor can be manifested by any number of phenomena including sheeting of the reactor walls, plugging of inlet and outlet lines (or nozzles), formation of large agglomerates, or other forms of polymer build up within the reactor that can lead to a shutdown of the reactor. The anti-static agent can be used as a part of a catalyst composition or introduced directly into the reactor independent of the catalyst composition. In one or more aspects, the anti-static agent can be included on a support that also supports one or more catalysts.

The term “catalyst” can be used interchangeably with the terms “catalyst compound,” “catalyst precursor,” “transition metal compound,” “transition metal complex,” and “pre-catalyst.”

A “catalyst system” is a combination of one or more catalyst compounds, an activator, an optional co-activator, and an optional support material. For the purposes of the present disclosure, when catalyst systems are described as comprising neutral stable forms of the components, it is well understood by one of ordinary skill in the art, that the ionic form of the component is the form that reacts with the monomers to produce polymers. Catalyst systems, catalysts, and activators of the present disclosure are intended to embrace ionic forms in addition to the neutral forms of the compounds/components.

The terms “group,” “radical,” and “substituent” may be used interchangeably herein.

The term “hydrocarbon” refers to a class of compounds having hydrogen bound to carbon, and encompasses saturated hydrocarbon compounds, unsaturated hydrocarbon compounds, and mixtures of hydrocarbon compounds (saturated and/or unsaturated), including mixtures of hydrocarbon compounds having different numbers of carbon atoms. The term “Cₙ” refers to hydrocarbon(s) or a hydrocarbyl group having n carbon atom(s) per molecule or group, wherein n is a positive integer. Such hydrocarbon compounds may be one or more of linear, branched, cyclic, acyclic, saturated, unsaturated, aliphatic, or aromatic.

The terms “hydrocarbyl radical,” “hydrocarbyl group,” or “hydrocarbyl” may be used interchangeably and are defined to mean a group consisting of hydrogen and carbon atoms only and bearing at least one unfilled valence position when removed from a parent compound.

The term “optionally substituted” means that a hydrocarbon or hydrocarbyl group can be unsubstituted or substituted. Unless otherwise specified as being expressly unsubstituted, any of the hydrocarbyl groups herein may be optionally substituted. The term “substituted” means that at least one hydrogen atom in a parent hydrocarbyl group has been replaced with at least a non-hydrogen group, such as a hydrocarbyl group, a heteroatom, or a heteroatom-containing group,

An “olefin” is a linear, branched, or cyclic compound of carbon and hydrogen having at least one double bond. When a polymer or copolymer is referred to as including an olefin, e.g., ethylene and/or at least one C₃ to C₂₀ α-olefin, the olefin present in such polymer or copolymer is the polymerized form of the olefin. For example, when a copolymer is said to have an “ethylene” content of about 35 wt % to about 55 wt %, it is understood that the repeating unit/mer unit or simply unit in the copolymer is derived from ethylene in the polymerization reaction and the derived units are present at about 35 wt % to about 55 wt %, based on a weight of the copolymer. For the purposes of the present disclosure, ethylene shall be considered an α-olefin.

A “polymer” has two or more of the same or different repeating units/mer units or simply units (monomer units). A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “polyethylene copolymer”, “ethylene copolymer”, and “ethylene-based polymer” are used interchangeably to refer to a copolymer that includes at least 50 mol % of units derived from ethylene.

As used herein, the term “wax” includes a petrolatum also known as petroleum jelly or petroleum wax. Petroleum waxes include paraffin waxes and microcrystalline waxes, which include slack wax and scale wax. Commercially available waxes include SONO JELL® paraffin waxes, such as SONO JELL® 4 and SONO JELL® 9, available from Sonneborn, LLC.

The term “activator” refers to any compound or combination of compounds, supported or unsupported, which can activate a single site catalyst compound or component, such as by creating a cationic species of the catalyst component.

### Polymerization Processes and Activation of Catalyst Compounds

When utilizing a supported catalyst containing one or more catalyst compounds, it may become necessary to modify the final supported catalyst, such as to alter the kinetic profile during polymerization or change the composition of the polymer being produced, by introducing additional catalyst compound(s) onto the supported catalyst. The additional catalyst compound(s) being introduced may increase the loading of a catalyst already present upon the supported catalyst and/or introduce a different catalyst compound not already present upon the supported catalyst. One way in which modification of the supported catalyst may be performed is through contacting the supported catalyst within a catalyst slurry with a catalyst solution containing one or more the catalyst compounds, thereby producing a modified supported catalyst within the catalyst slurry (or, put another way, a modified catalyst slurry comprising the modified supported catalyst). Unfortunately, when producing a modified catalyst slurry in situ in the foregoing manner, the kinetic profile and/or contact time of the modified catalyst slurry must be precisely controlled. Inadequate kinetic control may, for example, lead to thermal swings and pressure differentials in the catalysis system resulting in causing rheological changes to the catalyst slurry and/or catalyst solution (the catalyst solution also being referred to as the “trim” comprising additional catalytic compounds). Such thermal swings could lead to interference with the catalysis system and or associated equipment, including sheeting. Alternatively, if the supported catalyst is not modified to a sufficient degree, off-specification polymer may be produced during the gas-phase polymerization reaction.

Without being bound by theory or mechanism, it is believed that a catalyst compound being introduced to a supported catalyst slurry from a catalyst solution may experience sub-optimal activation as a consequence of imprecise kinetic contact and resultant thermal and pressure imprecisions. Indeed, by regulating the contact time between a catalyst slurry containing the supported catalyst and the catalyst solution, activation of the catalyst compound introduced from the catalyst solution may be enhanced and control of the gas-phase polymerization system may be realized.

The aforementioned issues are particularly exacerbated in gas-phase polymerization systems comprising two or more catalyst lines and connected injection nozzles for transporting modified catalyst slurry to a reactor (e.g., three or more lines). As provided above, precise flow control of such fluids is necessary to ensure at least approximately desired contact time between a catalyst slurry and a catalyst solution to control and prevent thermal swings and pressure drop deviations to eliminate or reduce sheeting and other product and equipment issues. While using two or more catalyst lines can desirably help improve overall flow rate of catalyst to a reactor (and, in particular, modified catalyst slurry comprising modified supported catalyst resulting from contact of a catalyst slurry and catalyst solution), the use of multiple catalyst lines exacerbates some of the just-noted control problems. For example, one or more catalyst delivery lines may be substantially longer or substantially shorter than the other(s), e.g., due to different locations of delivery along a reactor. For instance, one line may be used to deliver catalyst to a higher elevation along the reactor; or to deliver catalyst to a distal wall of the reactor, requiring traversal farther around the reactor as compared to a catalyst line connected to the reactor at a more proximal location. Such differing lengths may mean different residence times for slurries flowing at roughly the same mass flow rate therethrough (as would be expected for multiple delivery lines being controlled collectively through system hydraulics per conventional methods). Further, the different residence times may result in a lesser or greater degree of activated catalyst compound(s) on the modified supported catalyst of the modified slurry being delivered to the reactor, ultimately resulting in effectively different catalyst particles (i.e., having different amounts and/or ratios of activated catalyst compounds thereon) being delivered to the reactor over the same time period. This can result in different polymer than intended being produced in the reactor, leading to product quality issues, sheeting, and other problems.

A similar problem is encountered when one or more catalyst delivery lines has measurably different temperature(s) compared to the other line(s). Again without wishing to be bound by theory, it is believed that temperature differentials can affect both flow rate (greater temperature means lower viscosity of the slurry, therefore greater flow rate) and activation rate (greater temperature is believed to increase activation rate, therefore directly impacting amounts and/or ratios of activated catalyst compounds on a supported catalyst being delivered to the reactor).

Moreover, one or more delivery line(s) can experience fouling at a greater rate than the other line(s), leading to slow mass flow rates therethrough, which also can impact residence time (and therefore amounts and/or ratios of activated catalyst compounds on the supported catalyst provided to the reactor).

All of the above problems can be further exacerbated when flowing catalyst slurry into a reactor through a nozzle. While nozzles may be highly effective at distribution of catalyst slurry within a reactor, they can also be prone to cause sheeting when modified catalyst slurry flowing therethrough has had inadequate mixing and/or contact time.

At least because of these unexpected issues encountered when utilizing multiple delivery lines to provide modified catalyst slurry to a reactor, one solution could be to utilize only a single delivery line—but at the cost of lower overall rate of delivery of catalyst to the reactor, particularly in delivery systems utilizing particular types of nozzles (which themselves can provide various benefits such as avoidance of sheeting or fouling in delivery of catalyst slurry to the reactor), as such systems might be subject to maximum permissible flow rates through each nozzle. The present inventors have instead recognized that a more robust solution to the problem lies in independent control of temperature and/or flow rate through each of the delivery lines—temperature being suitable because of the just-noted phenomenon that greater temperature means lower slurry viscosity (and therefore greater flow rate). In related embodiments, in some cases uniformity of contact time is not necessarily required; instead, achieving a minimum contact time may be the needed objective, while balancing against excessively slow flow rates that detrimentally impact process economics and/or flow dynamics. For instance, some catalyst particles may encounter no appreciable difference in level of activation after a minimum contact time. In these cases, independent control of the slurry flow rate through the delivery lines can be used to ensure that each line obtains a minimum contact time between catalyst slurry and catalyst solution. As a particular example, an exceedingly short delivery line might be controlled to restrict flow so as to obtain a minimum contact time. Absent independent controllability of one of these lines, then overall system flow would be substantially slower, potentially leading to other problems (and at the least resulting in undesirable slower production). As used herein, the term “contact time” in reference to the combined flow of catalyst slurry and catalyst solution may equivalently be referred to as the “residence time” of a modified catalyst slurry (the combination of catalyst slurry and catalyst solution) in a conduit such as a delivery line. Thus, for example, for a system including three delivery lines for modified catalyst slurry, the system can be controlled such that residence time of the modified catalyst slurry in the first line is greater than a first line residence time set-point; residence time of the modified catalyst slurry in the second line is greater than a second line residence time set-point; and residence time of the modified catalyst slurry in the third line is greater than a third line residence time set-point. Each of these set-points can be the same or different.

Flow rate control (which also necessarily means residence time control) of modified catalyst slurry in the delivery lines can be achieved directly through specialized valves such as pinch valves, or other slurry flow valves, that are suitable for controlling flow of a slurry through a conduit. As used herein, a “slurry flow valve” is a valve suitable for constricting flow of a slurry while not causing solids accumulation (e.g., agglomeration, settling out of slurry, or the like) at or near the valve. Advantageously, slurry-constricting valves allow for the reduction or elimination of void spaces where slurry solids may settle, as well as the reduction or elimination of tight channels that may become plugged up by solids of the slurry. Such valves are discussed in more detail below.

Accordingly, various approaches for controlling the contact time between the catalyst slurry and the catalyst solution in delivery lines to the reactor to afford improved polymerization performance are described in further detail herein. In particular, the approaches described herein pertain to independent fluid flow control by means of mechanical devices, line and injection nozzle temperature control, or a combination thereof.

In order for the embodiments of the present disclosure to be better understood, reference is now made to the drawings showing polymerization processes and reactor systems in which a modified catalyst slurry may be produced and fed to a gas-phase polymerization reactor. It is to be appreciated by one having ordinary skill in the art that additional elements such as pumps, heat exchangers, valves, and similar system components (in addition to those enumerated herein) may be present in the depicted processes and reactor systems, without departing from the scope of the present disclosure, but such elements have been omitted in the interest of clarity. Moreover, elements having a similar structure and function in multiple figures will utilize in-common reference characters herein, and such elements will only be described in detail at their first occurrence in the interest of brevity.

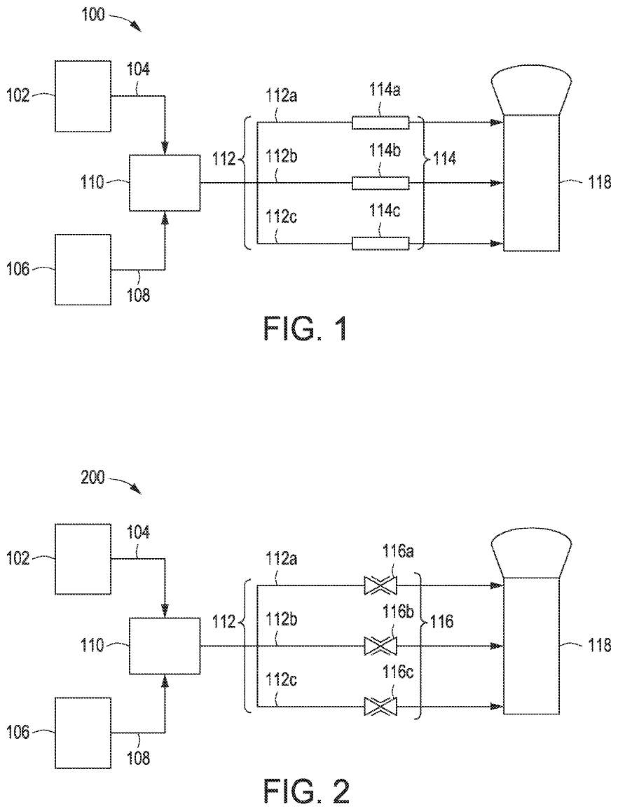

FIG. 1 is a block diagram schematic of gas-phase reactor system 100, in which mixing of a catalyst slurry and a catalyst solution may take place using a mixing unit 110. As shown, first catalyst-containing mixture containing a supported catalyst in a suitable carrier liquid can be introduced into first vessel 102. The supported catalyst may comprise a support material, at least one activator, and at least one catalyst compound; it can further comprise second, third, or more catalyst compounds, wherein each catalyst compound is different from the other(s). The first catalyst-containing mixture may be referred to as a catalyst slurry. The catalyst slurry can be held in first vessel 102, which optionally can be an agitated holding vessel configured to keep the solids concentration of the supported catalyst substantially constant in the catalyst slurry. In some embodiments, the holding vessel containing the catalyst slurry can be maintained at an elevated temperature, such as from 30° C., 40° C., or 43° C. to 45° C., 60° C., or 75° C. Elevated temperature can be obtained by electrically heating the holding vessel with, for example, a heating blanket. Maintaining the holding vessel at an elevated temperature can further reduce or eliminate solid residue formation on vessel walls which could otherwise slide off the walls and cause plugging in downstream delivery lines. In at least one embodiment, the holding vessel can have a volume of 0.75 m³, 1.15 m³, 1.5 m³, 1.9 m³, or 2.3 m³ to 3 m³, 3.8 m³, 5.7 m³, or 7.6 m³, or in the range of 0.75 m³ to 7.6 m³, encompassing any value and subset therebetween.

A second catalyst-containing mixture containing one or more of the same catalyst compound(s) as found on the supported catalyst of the slurry (e.g., the first catalyst compound and/or a second, third, fourth, etc. catalyst compound) may be introduced to second vessel 106. The second catalyst-containing mixture may be referred to as a catalyst solution, or catalyst “trim”. By contacting the catalyst slurry and catalyst solution as described below, a different amount and/or ratio of catalyst compound(s) on the supported catalyst can be achieved in-line and on-the-fly during production, enabling much greater control of continuous transitions from one polymer grade to another (wherein each different polymer grade may be achieved by differences in catalyst composition (including ratio and/or amount of catalyst compounds on the supported catalyst), among other polymerization operating parameters). The catalyst solution may be held in a tank having a sufficient volume to suitably modify the supported catalyst according to the description herein. The tank for the catalyst solution can have a volume of 0.38 m³, 0.75 m³, 1.15 m³, 1.5 m³, 1.9 m³, or 2.3 m³ to 3 m³, 3.8 m³, 5.7 m³, or 7.6 m³. The tank for the catalyst solution can be maintained at an elevated temperature, such as from 30° C., 40° C., or 43° C. to 45° C., 60° C., or 75° C., which may be obtained by electrically heating the tank with, for example, a heating blanket. Maintaining the tank at an elevated temperature can provide reduced or eliminated foaming when combining the catalyst slurry with the catalyst solution according to the description herein.

The catalyst slurry is conveyed through line 104 and the catalyst solution is conveyed through line 108 directly to mixing unit 110; optionally a jumpover line, e.g., a conduit connecting lines 104 and 108 (not shown in FIGS. 1-3), could be included to enable contact of slurry and solution upstream of the mixing unit 110, e.g., via diversion of at least a portion of catalyst solution from line 108 to line 104 (or vice-versa) via such jumpover line. The mixing unit 110 is not considered to be particularly limited and may include, but is not limited to, a static mixing unit (e.g. plate-type design, inline helical-type design, and the like) and/or a dynamic mixing unit (e.g., having an agitation mechanism, such as a turbine, propeller, and the like, such as a mixing pot containing such apparatus), although it may be preferred to utilize a jumpover line and/or a dynamic mixing unit to increase residence time and/or level of intermixing of the slurry and solution. The mixing unit can be maintained at an elevated temperature, such as from 30° C., 40° C., or 43° C. to 45° C., 60° C., or 75° C., using any suitable means such as electrical heating with, for instance, heating coils and/or a heating blanket. Elevated temperature may provide reduced or eliminated foaming in the mixing unit 110 and can provide enhanced mixing of the catalyst slurry and catalyst solution; and accordingly can reduce overall runtimes for the process. The mixing unit can have a total volume of about 10 L to about 30 L, or about 10 L to about 20 L, or about 15 L to about 25 L, or about 20 L to about 30 L. Volumes in the foregoing ranges may be sufficient to afford residence times of about 30-40 minutes in the mechanically agitated mixing pot.

Regardless of the mechanism and means of intermixing, a modified catalyst slurry comprising modified supported catalyst is obtained from intermixing the catalyst slurry and catalyst solution. The modified catalyst slurry is then conveyed to reactor 118 via lines (having injection nozzles connected thereto) 112 (112a, 112b, and 112c). The lines 112 may enter the reactor 118 at multiple locations, be of differing lengths, and/or at different flow rates, as described herein. For example, the lines 112 may be in the range of about 20 feet to about 30 feet (about 6 meters to about 9 meters) long and may be the same or different lengths, and such lengths may be based on the fluid connection location of a particular line 112 to the reactor 118 (e.g., if the reactor 118 is circumferential, one injection nozzle connected to line 112 may fluidly connect to a proximal portion of the reactor with respect to the mixing unit 110, and another injection nozzle may fluidly connect to a distal portion of the reactor with respect to the mixing unit 110, necessitating differing injection line lengths). It should be appreciated that while three lines 112 (112a, 112b, 112c) are depicted in FIG. 1, the system 100 may comprise two lines, or alternatively may comprise more than three lines 112 (e.g., 112a, 112b, 112c, and 112d).

As noted above, independently regulating the flow of modified catalyst slurry in the lines can be of particular importance, in order to deliver to the reactor 118 modified supported catalyst having substantially the same amounts and/or ratios of activated catalyst compound(s) thereon. This goal may be referred to herein as balancing modified catalyst slurry distribution to the reactor.

In one or more aspects of the present disclosure, and as depicted in FIG. 1, temperature control may be used to regulate flow rate (and as a result regulate contact, or residence, time) because temperature can affect the rheology (e.g., viscosity) of the modified catalyst slurry and influence flow rate through the lines (and injection nozzles) 112, as described in greater detail below. So, as one example (and with continued reference to FIG. 1), lines 112 may each have heating block 114 (114a, 114b, 114c, respectively). Heating blocks 114 may allow for regulation of temperature (and, indirectly, flow rate of modified catalyst slurry) in individual lines (and injection nozzles) 112 in order to balance modified catalyst slurry distribution to the reactor 118 through each of the lines 112. The temperature of each line 112 may be regulated such that the flow rate of lines 112 are within 10% of each other (or 20%, or 30%, or 40%, or 50%), as measured relative to a selective line 112 (e.g., line 112a (i.e., the first injection line)). Most preferably, flow rate through each line would be measured at the respective nozzles through which catalyst slurry exits the lines 112 into the reactor 118, and such a measured flow rate can be referred to as a nozzle flow rate. Typically, the heating blocks 114 may maintain the temperature of the modified catalyst slurry within lines 112 between about 40° C. and 50° C., for example. However, it is noted that while equal or near-equal temperatures across the lines are preferred in normal operation, methods of the present disclosure expressly include controlling one, two, or more of the lines to have temperature differing from one or more of the other line(s) in order to, e.g., achieve more uniform contact (or residence) times of modified catalyst slurry in the lines; or to compensate for fouling in such line(s). For example, where one line encounters reduced flow (e.g., below a set point flow rate) due to fouling, temperature in that line (but not the others) can be increased to reduce viscosity (as described in more detail below), thereby increasing flow rate back to the set point flow rate.

It should be noted that each line 112 may have more than one heating block 114, and individual heating blocks may be active in varying degrees (temperatures) and at varying times. The heating blocks 114 may be coupled to a suitable control system for maintaining a set point (of flow rate, temperature, or residence time), as would be known in the art.

Without being bound by theory, a heating block may allow for regulation of flow rate (and thus regulation of contact, or residence, time) of a fluid stream due to control of temperature. Controlling temperature of a fluid stream (e.g., the modified catalyst slurry) alters the viscosity (ASTM D445-21) of the stream which in turn leads to increased or decreased pressure drop within a conduit (e.g., line and injection nozzle). The viscosity of the modified catalyst slurry may range from 100 cP to 2000 cP (or 0.1 cP to 3000 cP, or 0.1 cP to 2000 cP, or any constituent ranges therebetween). The increase or decrease in pressure drop within a conduit will, again without being bound by theory, lead to regulation of flow because the parallel conduits will be forced to equilibrate pressure drop due to having the same starting point and ending point. For example, if temperature is increased in line 112a using heating block 114a, the viscosity (ASTM D445-21) of the modified catalyst slurry in line 112a will decrease, which will decrease the pressure drop; however, since the lines must equilibrate, the flow will increase in line 112a to compensate.

The heating blocks may utilize varying means of heating and/or cooling the modified catalyst slurry. Heat tracing may be utilized as part of one or more heating blocks. The heat tracing may comprise insulation in addition to a heating or cooling element itself.

The heat tracing may comprise heat transfer fluid in an auxiliary conduit (i.e., a conduit in physical contact with the injection nozzle(s) supplying the reactor). The auxiliary conduit may coil around the line(s) and/or injection nozzle(s) of the system, may be configured in parallel with the line(s) of the system, and the like, or any combination thereof The auxiliary conduit may be composed of any suitable material for withstanding pressures and temperatures of the heat transfer fluid or other heating/cooling element used therein. The auxiliary conduit may be sized to any suitable diameter and may be larger than or smaller than the line(s) and/or injection nozzle(s) supplying the reactor. The auxiliary conduits may have varying diameters. It should be noted that more than one auxiliary conduit may be used for each line of the system of the present disclosure.

The heat transfer fluid may comprise any suitable fluid for providing heat transfer functionality. Particularly useful heat transfer fluids are those stable at the temperatures and pressures required to heat and cool the line(s) and injection nozzle(s) to the reactor which convey the modified catalyst slurry. Examples of suitable heat transfer fluid include, but are not limited to, water, aqueous solutions (e.g., brine), molten salt, oil (e.g., hydrocarbons, such as mineral oil, kerosene, hexane, pentane, propane and the like), glycol (e.g., propylene glycol, ethylene glycol, bioglycol (1,3 propanediol)), refrigerants (R12, R134a, and the like), or synthetic media, such as those available from DOW Chemical Company under the trade name DOWTHERM™, such as grades A, G, J, MX, Q, RP, and T, and those available from EASTMAN Chemical Company under the trade name THERMINOL™, such as grades 59, XP. Heat transfer fluids according to the present disclosure may comprise any combination of suitable (compatible) heat transfer fluids.

The heat transfer fluid may be selected based on factors including, but not limited to, operational temperature ranges of the modified catalyst slurry, operational temperature ranges of a reactor system described by the present disclosure, and the like, or any combination thereof. The heat transfer fluid may heat or cool the line(s) and injection nozzle(s) feeding the reactor and the modified catalyst slurry therein.

The auxiliary conduit may be connected to a heater or chiller, or other suitable heating/cooling element or means to regulate the temperature of the heat transfer fluid to the desired temperatures.

The heat tracing may comprise electric heat tracing which may comprise any suitable type

of electric heating means including, but not limited to, constant power heat tracing, constant wattage heat tracing, self-regulating heat tracing, and the like, or any combination thereof The electric beat tracing may be selected based on factors including, but not limited to, operational temperature ranges of the modified catalyst slurry, operational temperature ranges of a reactor system described by the present disclosure, and the like, or any combination thereof.

The heating blocks may comprise one or multiple auxiliary conduits, one or multiple electric heat tracing elements, or any combination thereof.

Referring again to FIG. 1, other components may be delivered to reactor 118 via delivery lines 112, either being combined with the modified catalyst slurry in one or more lines and/or introduced in one or more separate lines not containing the modified catalyst slurry. Such other components are discussed in more detail below.

Further, it should be understood that while a modified catalyst slurry that includes at least two catalyst compounds is described herein, the modified catalyst slurry may comprise a single catalyst compound if suitable for a particular process (e.g., where the supported catalyst comprises the catalyst compound deposited thereon; and the catalyst solution comprises the same catalyst compound, such that control of the amount of catalyst solution mixed with catalyst slurry de facto controls amount of deposited catalyst compound). Likewise, the modified catalyst slurry could comprise three or more catalyst compounds, depending on particular process requirements (e.g., one, two or three compounds could be present on the supported catalyst in the slurry; and one or two catalyst compounds added by the solution to provide on-the-fly control of the ratio of the compounds; and so on for different numbers of different catalyst compounds).

Reactor 118 can include a reaction zone and a velocity reduction zone. The reaction zone can include a bed that can include growing polymer particles, formed polymer particles and an amount of catalyst particles fluidized by the continuous flow of a gaseous monomer and diluent to remove the heat of polymerization through the reaction zone. An olefinic feed gas may be provided to reactor 118 and recirculated therethrough. Optionally, some of the re-circulated gases can be cooled and compressed to form liquids (e.g., where the gases include induced condensing agents), that can increase the heat removal capacity of the circulating gas stream when readmitted to the reaction zone. Make-up of gaseous monomer to the circulating gas stream can be at a rate equal to the rate at which particulate polymer product and monomer associated therewith is withdrawn from the reactor and the composition of the gas passing through the reactor can be adjusted to maintain an essentially steady state gaseous composition within the reaction zone. The gas leaving the reaction zone can be passed to the velocity reduction zone where entrained particles can be removed, for example, by slowing and falling back to the reaction zone below the velocity reduction zone. If desired, finer entrained particles and dust can be removed in a separation system, such as a cyclone and/or fines filter. The recirculating gas can be passed through a heat exchanger where at least a portion of the heat of polymerization can be removed and/or the recirculating gas can be compressed and returned to the reaction zone.

In another suitable process configuration of the present disclosure, the flow rate of individual lines and injection nozzles feeding a reactor may be regulated by slurry flow valves. FIG. 2 is a block diagram schematic of gas-phase reactor system 200, in which flow rates of individual lines are regulated by slurry flow valves (e.g., pinch valves, as described below). As shown in FIG. 2, a catalyst slurry is again (c.f. FIG. 1) provided from first vessel 102 into line 104, and a catalyst solution is again (c.f. FIG. 1) provided from second vessel 106 into line 108. After, a modified catalyst slurry is obtained from mixing unit 110, the modified catalyst slurry may be conveyed to reactor 118 via lines (and injection nozzles) 112 (112a, 112b, 112c), as described above in reference to FIG. 1. In order to regulate flow rate (and as a result regulate contact or residence time), lines 112 may each have a slurry flow valve 116 (116a, 116b, 116c). Slurry flow valves 116 may allow for flow regulation of individual lines (and injection nozzles) 112 in order to balance modified catalyst slurry distribution to the reactor 118. It should be noted that each line may have more than one slurry flow valve, and individual slurry flow valves may be open to varying degrees (including completely opened or completely closed) and at varying times. Moreover, two lines or more than three lines comprising one or more slurry flow valves may be included in the system of FIG. 2.

As described above, in conventional reactor systems, conventional control valves (e.g., gate valves, ball valves, globe valves, etc.) may be used; however, conventional control valves are not favored due to the partially-solid nature of the modified catalyst slurry. Without being bound by theory, conventional control valves may erode due to the solids within the modified catalyst slurry or may provide stagnant flow regions in which slurry may plug up lines due to settling of solids.

As noted previously, slurry flow valves should be employed for regulating flow through each of the catalyst slurry delivery lines. Suitable slurry flow valves include, e.g., pinch valves. Pinch valves function through the constriction of an internal elastomeric sleeve which pinches the flow therein, thereby increasing pressure drop and reducing flow.

Other examples of slurry constricting valves can include rotary globe valves. However, rotary globe valves can include a tortuous flow path. which can pose difficulty for slurry flow. In such valves, fluid flows from an upper conduit, into and up through a rotatable vertical conduit, and out of an orifice disposed alongside the vertical conduit, into an upper conduit. Rotation of the vertical conduit can move the orifice perpendicularly away from the upper conduit, thereby effectively closing off flow. For purposes of the present disclosure, a rotary globe valve could nonetheless be deployed by reversing the standard fluid flow direction therethrough, e.g., by having fluid flow through the upper conduit, into and down through the rotatable vertical shaft, and out into the lower conduit. Such a configuration would allow precise control of slurry flow rate while avoiding agglomeration in the valve.

Slurry flow valves used in some systems in accordance with the present disclosure may be manually operated or mechanically operated by any suitable means including, but not limited to, electronic, pneumatic, or hydraulic operation. Such valves may be coupled to a suitable control system known in the art. Suitable pinch and/or rotary globe valves are available from vendors such as VALMET Company.

Processes and systems utilizing one or more slurry flow valves, such as slurry flow valves 116 on each of multiple delivery lines (e.g., lines 112) in accordance with FIG. 2 advantageously include control of flow rate in each line 112 independent of the other line(s) 112. For instance, flow rate may be increased in one line 112 having a substantially longer traversal length from mixing unit 110 to reactor 118 as compared to other lines 112, in order to achieve substantially similar overall residence (or contact) time for all modified supported catalyst being provided to the reactor 118 in the modified catalyst slurry. As another example, where fouling reduces flow rate in one line 112 as compared to a set point flow rate, pinch valves in the line 112 with fouling can be opened further to increase flow rate back to the set point; or, alternatively, slurry flow valves in other line(s) 112 can be partially closed to decrease flow rates in those lines in order to more closely match flow rate in the partially obstructed line 112, thereby maintaining more uniform residence times for modified catalyst slurry among the delivery lines 112. As yet another example, flow through one line 112 can be decreased in order to obtain a minimum desired contact time between catalyst slurry ad catalyst solution, while not decreasing flow through the other lines 112, so as to obtain a minimum desired contact time without detrimentally impacting overall rate of production.

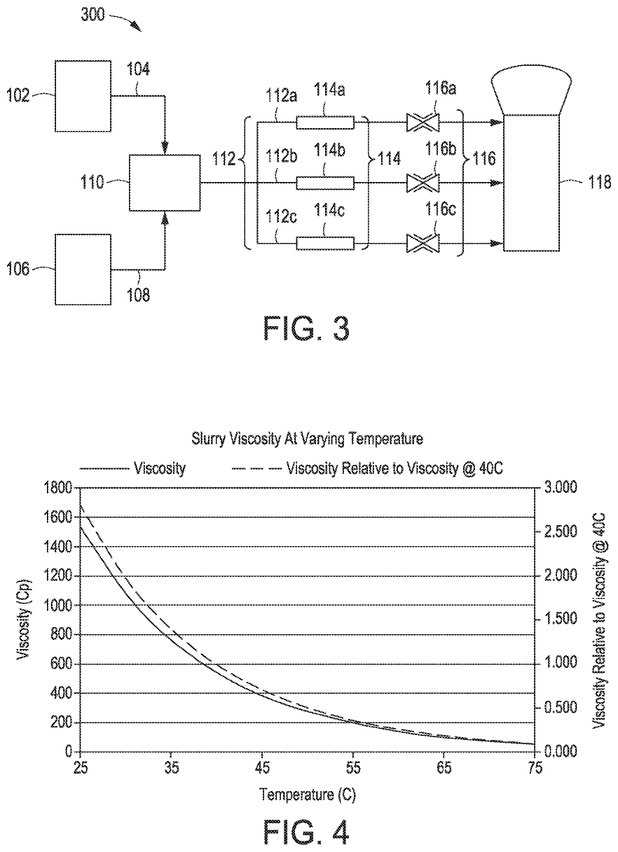

Yet another suitable process configuration of the present disclosure may comprise independently regulating the flow rates of individual lines and injection nozzles feeding a reactor with a combination of slurry flow valves and heating blocks. FIG. 3 is a block diagram schematic of gas-phase reactor system 300, in which in which flow rates of individual lines (and injection nozzles) are regulated by slurry flow valve(s) and a heating block(s). As shown in FIG. 3, catalyst slurry is again (c.f. FIGS. 1 and 2) provided from first vessel 102 into line 104, and a catalyst solution is again (c.f. FIGS. 1 and 2) provided from second vessel 106 into line 108. After, a modified catalyst slurry has been obtained from mixing unit 110, the modified catalyst slurry may be conveyed to reactor 118 via lines (and injection nozzles) 112, as described above in reference to FIGS. 1 and 2. In order to regulate flow rate (and as a result regulate contact or residence time), lines 112 may each have a heating block 114 (114a, 114b, 114c) and/or a slurry flow valve 116 (116a, 116b, 116c), as described above in reference to FIGS. 1 and 2, respectively. It should be noted that, while FIG. 3 depicts each line 112 with one heating block 114 and one slurry flow valve 116, each line 112 may individually have a heating block 114 and/or a slurry flow valve 116 singly or in any combination, each line 112 may have more than one heating block 114 and/or more than one slurry flow valve 116, and each line may have one or more of a heating block 114 and one or more of a slurry flow valve 116 either upstream or downstream of one another, without departing from the scope of the present disclosure.

Without being bound by theory, it is to be appreciated that the temperature of the catalyst slurry going through line 104 and the catalyst solution going through line 108 may additionally be temperature-controlled because temperature can impact how easy it is for solids to settle out of the catalyst slurry and catalyst solution and plug the lines 104,108 and can influence the solid catalyst activation. So in one or more embodiments, the lines 104,108 additionally comprise heating blocks and slurry flow valves.

### Control of the Reaction Systems and Methods

In various embodiments, the goals of the control of slurry flow valves and/or heating blocks (and therefore the relevant set point(s)) include achieving substantially similar amounts and/or ratios of activated catalyst compound(s) on the modified supported catalyst provided to the reactor in the modified catalyst slurry (meaning the amount of any catalyst compound(s) on the various particles of modified supported catalyst differ by no more than 5 wt %, preferably no more than 10 wt %, such as no more than 15 wt % among particles of the modified supported catalyst, where such wt % are on the basis of mass of the activated catalyst compound as a percentage of mass of modified supported catalyst). Also or instead, ratio of activated catalyst compound A to activated catalyst compound B on the various particles of modified supported catalyst is controlled to be within +/−15%, such as +/−10%, or +/−5%, as compared to a reference ratio of activated A to activated B selected from among the particles of modified supported catalyst. Also or instead, it is desired that each line of catalyst slurry delivered to the reactor has a similar wt % of solids in each slurry (e.g., such that the solids wt % in modified catalyst slurry delivered in the first, second, third, etc. lines is within 5, 10, or 15 wt % of one another).

Because these properties can be difficult to measure directly, however, various set points can be used as proxies for this control scheme, such as any one or more of residence time and flow rate in each line 112. Also, as discussed elsewhere in this disclosure, temperature can advantageously be used as a proxy for flow rate since higher temperatures can lead to higher flow rates of the modified catalyst slurry; therefore, temperature in each line 112 may itself be a viable set point for control schemes of this disclosure. It will be appreciated further that the set points of these values may be similar across different delivery lines 112 in various situations; for example, similar or equal flow rate set points may be desired where delivery lines 112 have similar lengths, while different flow rate set points (but similar residence time set points) may be desired where delivery lines 112 have different lengths. Temperature set points can suitably be used as proxies to achieve such similar flow rates or different flow rates but similar residence times. Furthermore, independent control of each delivery line 112 advantageously enables maintaining conditions at the desired set point even in the face of fouling or other deviations that affect only some but not all lines 112. Thus, methods and control systems of some embodiments can include detecting fouling in one of the lines 112 and in response, either increasing the flow rate in said line; or decreasing the flow rate in each of the other line(s) 112. Increasing flow rate can be accomplished, e.g., by further opening a slurry flow valve and/or by increasing temperature (using a heating block); and decreasing flow rate can be accomplished, e.g., by partially closing a slurry flow valve and/or by decreasing temperature.

In the discussion above, a residence time, flow rate, and/or temperature can be considered similar where such value in one line is within 15% (preferably within 10%, more preferably within 5%, such as within 1%) of that value in each of the other lines. For instance, control can be carried out such that residence time of modified catalyst slurry in a first line is within 15%, preferably within 10%, more preferably within 5%, most preferably within 1%, of residence time of the modified catalyst slurry in each of the second, third, etc. lines.

In yet further embodiments, the goal of uniform ratios of activated A to activated B in the modified catalyst slurry could be achieved simply through use of a minimum set-point residence time and/or maximum flow rate (or through use of a proxy set-point, such as temperature, at which the minimum residence time would be achieved), rather than controlling to uniformity of such set-points in each line. This could be advantageous where greater contact time past a certain point will not substantially modify the catalyst composition, such that the goal of uniform ratios of activated A to activated B are achieved simply through enforcing the minimum residence time/maximum flow rate. Nonetheless, even in these scenarios, a maximum residence time (minimum flow rate) might be preferred, because if residence time increases past a certain point, then one can encounter control lag (excessive time between a control operation being taken and impact on the composition entering the reactor being realized), in addition to undesirably reduced overall output rates.

Generalizing the above discussion for references to control methods, the modified catalyst slurry can be introduced into the polymerization reactor via two or more lines in fluid contact with the polymerization reactor, such as 2, 3, 4, or more lines. It is also contemplated that multiple modified catalyst slurries having different compositions may be introduced via two or more lines in fluid contact with the polymerization reactor. Such lines may include specialized equipment used for conveying the modified catalyst slurry/slurries through the line and into the polymerization reactor. Examples of such specialized equipment include, but are not limited to, slurry flow valves (such as pinch valves), nozzles such as spray nozzles and solid stream nozzles, temperature controllers, the like, and any combination thereof. The specialized equipment may be used to control the uniformity of the catalyst entering the reactor. The line(s) entering the polymerization reactor may be temperature controlled either upstream of the specialized equipment or within the equipment itself, as described herein. The temperature controls may aid in regulating the viscosity of the modified catalyst slurry and limit temperature variability within the reactor as a consequence of the modified catalyst slurry/slurries entering the polymerization reactor at different rates. Each line and injection nozzle may be operated with independent flow control and/or independent temperature control. That is, each line and injection nozzle combination can be operatively connected to a control system configured to control each line and injection nozzle independently of the others. For example, a control system could include a controller (not shown in FIGS. 1-3) that in turn includes a computer system, microcontrollers, programmable logic controller, or any other control system capable of monitoring and adjusting process variables within the gas-phase reactor system 100; and the controller may be operatively connected to one or more other devices to carry out the control, including sensors, actuators, and the like.

For example, the control system can include one or more actuators associated with each slurry flow valve 116 and/or each heating block 114 in FIGS. 1-3 above; and the actuators are each operatively connected to the controller, which in turn is configured to control each slurry flow valve independently from the others, and/or to control each heating block independently of the others. The control system, for example, can include at least one processor (e.g., processing circuitry, a central processing unit (CPU), a graphics processing unit (GPU)), at least one memory (e.g., random access memory (RAM), read-only memory (ROM), non-transitory computer-readable media), and at least one storage (e.g., a solid state disk, a hard drive, a flash drive). The memory and/or storage can be designed to store instructions (e.g., software instructions, computer-executable code) executed by the at least one processor, as well as data (e.g., inputs, outputs, intermediates), to perform the techniques described herein (e.g., independent control of slurry flow valves 116 and/or heating blocks 114). Optionally, the control system could further include at least one networking device (e.g., a wired or wireless networking interface) that enables the system to send and receive data, such as receiving inputs from users, receiving information about the configuration or operation of other components of the gas-phase reactor system 100, adjusting the configuration or operation of other components of the gas-phase reactor system 100, providing outputs to users, and so forth. In some embodiments, the control system may be implemented separately from the gas-phase reactor system 100, such as in a server room, in a data center, or in a cloud-based environment.

Put more generally, such control systems (or others as would be known in the art) could be referred to as a control system configured for independent control of each individual slurry flow valve (and/or each individual heating block); or equivalently as a control system configured to control each slurry flow valve (and/or each heating block) independently of the others.

Alternatively, manual control could be used to carry out the methods described herein for independently controlling each slurry flow valve and/or heating block, for example in situations where active automatic control is not expected to be necessary, but instead a one-time initial adjustment is required (e.g., controlling a slurry flow valve to reduce flow rate in a delivery line that is substantially shorter than other delivery line(s) so as to obtain similar residence (contact) times for modified catalyst slurry being delivered through all lines).

Of course, manual control and automatic/mechanical control are not necessarily mutually exclusive, either; one could easily envision an automatic control system with manual override suitable for manual setting of a slurry flow valve and/or heating blanket.

In summary, then, according to the present disclosure: a modified catalyst slurry and one or more olefins, among other potential streams, may be introduced into a polymerization reactor, preferably a gas-phase reactor, more preferably a fluidized bed gas-phase reactor. The modified catalyst slurry may be obtained by combining an initial catalyst slurry containing a supported catalyst comprising at least one catalyst compound with a catalyst solution comprising a first catalyst compound already contained upon the supported catalyst and/or a second catalyst compound not already contained upon the supported catalyst. The supported catalyst may further comprise at least one activator upon a support material, in addition to the at least one catalyst compound. The catalyst slurry and the catalyst solution may each comprise a carrier liquid suitable for conveying the supported catalyst and catalyst compound(s) therein, and in which contact between the supported catalyst of the catalyst slurry and the catalyst compound(s) of the catalyst solution may take place. The carrier liquid in the catalyst slurry and the catalyst solution may be the same or different. By contacting the catalyst slurry with the catalyst solution, a different catalyst compound may be introduced onto the support material and/or the loading of at least one catalyst compound upon the support material may be increased. Upon contacting the activator upon the support material, a modified catalyst slurry having modulated activity for conducting a polymerization reaction may be obtained. In non-limiting examples, the modified catalyst slurry may be less prone to temperate or flow aberrant issues during polymerization as a direct consequence of the regulated contact time between the catalyst slurry and the catalyst solution afforded by the disclosure herein.

Accordingly, some methods for regulating contact time between a catalyst slurry and a catalyst solution according to the present disclosure may comprise: obtaining a catalyst slurry comprising a supported catalyst, the supported catalyst comprising a support material, at least one catalyst compound, and at least one activator; introducing the catalyst slurry to a first line in fluid communication with a mixing unit; introducing at least a first portion of a catalyst solution to a second line in fluid communication with the mixing unit, the catalyst solution comprising a first catalyst compound already contained upon the supported catalyst or a second catalyst compound different from the first catalyst compound and not contained upon the supported catalyst; contacting the catalyst slurry with the catalyst solution in the mixing unit to obtain a modified catalyst slurry, the modified catalyst slurry comprising a modified supported catalyst incorporating at least a portion of the first catalyst compound or the second catalyst compound from the catalyst solution; feeding the modified catalyst slurry to a fluidized bed gas-phase reactor through two or more delivery lines; regulating the flow of modified catalyst slurry through each of the two or more delivery lines utilizing heating block(s) and/or slurry flow valve(s) such that flow of the modified catalyst slurry through each delivery line is regulated independently of the other(s); and polymerizing an α-olefin in the fluidized bed gas-phase reactor under polymerization conditions to obtain a polyolefin.

The catalyst-containing mixtures (i.e., the catalyst solution and/or the catalyst slurry) may be pre-blended by the mixing unit (e.g., mixing unit 110 as discussed above) prior to being introduced to the polymerization reactor. To enhance the mixing efficiency prior to polymerization (i.e., to increase the contact time of the catalyst-containing mixtures), the catalyst-containing mixtures may be further contacted in-line upstream from the mixing unit by utilizing a jumpover line. The jumpover line may comprise tubing or piping in which at least a portion of the catalyst-containing mixtures are diverted for pre-mixing upstream from the mixing unit. For example, the jumpover line may facilitate contact times between the catalyst-containing mixtures before entering the mixing unit of about 4, 5, or 6 minutes to about 6, 7, 8, 9, or 10 minutes (such as about 5 minutes to about 6 minutes, or about 6 minutes to about 7 minutes). Use of certain mixing units (e.g., mixing pots) can further increase contact time, if desired; and the methods described herein for regulating residence time in feed lines conducting catalyst particles from the mixing unit to the reactor may of course be adjusted to achieve an overall desired contact time (taking into account overall contact times for catalyst slurry and catalyst solution based upon the presence or absence of jumpover line(s) and mixing unit(s), as well as type of mixing unit(s) upstream of the fee lines). Thus, regulating modified catalyst slurry flow through such feed lines can include achieving target residence time(s) based at least in part upon contact time(s) already achieved upstream of such feed lines.

### Catalyst Slurry Catalyst Solution, and Modified Catalyst Slurry

The catalyst slurry and the modified catalyst slurry can include at least a carrier liquid and at least one catalyst compound upon a supported catalyst. Optionally, the catalyst slurry may further include one or more waxes, mineral oil, induced condensing agents, or any combination thereof. In some embodiments, the carrier liquid may be or can include, but is not limited to, one or more mineral oils and/or one or more waxes, optionally in further combination with an induced condensing agent.

It is also noted that some components present within the polymerization reactor may be fed to the reactor via the modified catalyst slurry (e.g., the optional induced condensing agent, a carrier fluid, such as nitrogen, or the like) or may additionally or alternately be fed to the reactor via other means. For example, induced condensing agents in gas-phase polymerization processes, and in particular fluidized bed gas phase polymerization processes, may be provided to the process in a cycle gas flowing up through the fluidized bed in the polymerization reactor, or they may also be provided in other streams that are not the modified catalyst slurry or the cycle gas. Cycle gas may refer to a gas stream comprising an olefinic feed that is circulated through the reactor and replenished with additional olefins when needed.

In some embodiments, the catalyst slurry or the modified catalyst slurry can include 1 wt %, 5 wt %, 8 wt %, or 10 wt % to 15 wt %, 20 wt %, 25 wt %, 30 wt %, 35 wt %, or 40 wt % of solids, based on a total weight of the catalyst slurry or modified catalyst slurry. The solids include the catalyst compound(s), a support material, an activator, and, if present, any other solid component(s). The wax, if present in the carrier liquid, is considered a liquid component and not a solid component For example, if the catalyst slurry or modified catalyst slurry includes a first catalyst, a second catalyst, a support, an activator, and the carrier liquid that includes a mineral oil and a wax, the solid components include the first and second catalysts, the support, and the activator; and the liquid components include the mineral oil and the wax.

The modified catalyst slurry can include a first catalyst compound and a second catalyst compound, wherein the first catalyst compound is capable of producing a high molecular weight polymer and a second catalyst compound is capable of producing a low molecular weight. In other words, the first catalyst compound can be one that makes primarily high molecular-weight polymer chains, and the second catalyst compound makes primarily low molecular-weight polymer chains, which may be dependent upon the catalyst structure and conducting the polymerization reaction under specified polymerization conditions. Thus, in some examples, the polymer product produced under the polymerization conditions by the modified catalyst slurry may comprise both the high- and low-molecular weight polymers The two catalyst compounds can be present in the modified catalyst slurry in a molar ratio of the first catalyst compound to the second catalyst compound of 99:1 to 1:99, 90:10 to 10:90, 85:15 to 15:85, 75:25 to 25:75, 60:40 to 40:60, 55:45 to 45:55 In some embodiments, the first catalyst compound and/or the second catalyst compound can also be added to the catalyst slurry as a trim catalyst from a catalyst solution to adjust the molar ratio of the first catalyst compound to the second catalyst compound. In at least one embodiment, the first catalyst compound and the second catalyst compound can each be a metallocene catalyst, as described further below.

As just noted, one or more induced condensing agents (ICAs) can be introduced into the reactor; such ICAs can increase the production rate of polymer product. ICA may be present in the catalyst slurry, the catalyst solution, or the modified catalyst slurry resulting from contacting the catalyst slurry with the catalyst solution. Alternately, at least a portion of the ICA may be combined with the modified catalyst slurry in the line leading from the mixing device to the reactor (e.g., in line(s) 112 as illustrated in FIGS. 1-3), or the ICA can be introduced to the reactor independently of the catalyst slurry. The ICA agent can be condensable under the polymerization conditions within the polymerization reactor. The introduction of an ICA into the reactor is often referred to as operating the reactor in “condensed mode.” The ICA can be non-reactive in the polymerization process, but the presence of the ICA can increase the production rate of the polymer product. The ICA can be or can include, but is not limited to, one or more alkanes. Illustrative alkanes can be or can include, but are not limited to, propane, n-butane, isobutane, n-pentane, isopentane, neopentane, n-hexane, isohexane, n-heptane, n-octane, or any mixture thereof. Further details on induced condensing agents can be found in U.S. Pat. Nos. 5,352,749; 5,405,922; 5,436, 304; and 7,122,607; and International Patent Application Publication Number WO 2005/113615(A2).

As noted, such ICA(s) can be added to the modified catalyst slurry in-line; this may be the main source of ICA provided to the reactor, or may be in addition to any other ICA separately introduced to the reactor, e.g., through recycle gas introduced to the reactor. The induced condensing agent can be introduced to the modified catalyst slurry such that the delivery rate of ICA to the reactor (through the line(s)/nozzle(s)) is within a range from a low of any one of about 0.4 kg/hr, 1 kg/hr, 5 kg/hr, or 8 kg/hr to a high of any one of about 11 kg/hr, 12 kg/hr, 15 kg/hr, 20 kg/hr, 23 kg/hr, or 45 kg/hr, on a per-line or per-nozzle basis (such that the aforementioned total ICA delivery rate to a reactor could be determined by multiplied the aforementioned per-nozzle rates by, e.g., 5, when 5 lines/nozzles are used).

When the catalyst slurry or modified catalyst slurry also includes an induced condensing agent, the induced condensing agent may constitute 30 to 90 wt % of the catalyst slurry or modified catalyst slurry by weight, such as 30, 35, 40, 45, or 50 wt % to 60, 70, 80, or 90 wt % of the catalyst slurry or modified catalyst slurry by weight. In some embodiments, when the catalyst slurry or modified catalyst slurry also includes a mineral oil and a wax in addition to the induced condensing agent, the mineral oil may constitute from a low of 8, 15, 20, or 25 wt % to a high of 40, 50, 60, or 68 wt % of the catalyst slurry or modified catalyst slurry, the wax may constitute from a low of 2, 5, or 7 wt % to a high of 10, 12, or 15 wt % of the catalyst slurry or modified catalyst slurry, and the induced condensing agent may constitute from a low of 30, 40, 45, or 50 wt % to a high of 60, 70, 80, or 90 wt % of the catalyst slurry or modified catalyst slurry, each based on the total mass of the catalyst slurry or modified catalyst slurry.

The wax, if present, can increase the viscosity of the catalyst-containing mixture. In at least one embodiment, the wax, if present, can have a density (at 100° C.) of 0.7 g/cm³, 0.73 g/cm³, or 0.75 g/cm³ to 0.87 g/cm³, 0.9 g/cm³, or 0.95 g/cm³. The wax, if present, can have a kinematic viscosity at 100° C. of 5 cSt, 10 cSt, or 15 cSt to 25 cSt, 30 cSt, or 35 cSt. The wax, if present, can have a melting point of 25° C., 35° C., or 50° C. to 80° C.′, 90° C., or 100° C. The wax, if present can have a boiling point of 200° C. or greater, 225° C. or greater, or 250° C. or greater.

It should be understood that the term “wax” also refers to or otherwise includes any wax not considered a petroleum wax, which include animal waxes, vegetable waxes, mineral fossil or earth waxes, ethylenic polymers and polyol ether-esters, chlorinated naphthalenes, and hydrocarbon type waxes. Animal waxes can include beeswax, lanolin, shellac wax, and Chinese insect wax. Vegetable waxes can include carnauba, candelilla, bayberry, and sugarcane. Fossil or earth waxes can include ozocerite, ceresin, and montan. Ethylenic polymers and polyol ether-esters include polyethylene glycols and methoxypolyethylene glycols. The hydrocarbon type waxes include waxes produced via Fischer-Tropsch synthesis.

In some embodiments, the catalyst slurry, the catalyst solution, or the modified catalyst slurry can be free of any wax having a melting point of ≥25° C. In other embodiments, the catalyst slurry, the catalyst solution, or the modified catalyst slurry can include ≤3 wt %, ≤2.5 wt %, ≤2 wt %, ≤1.5 wt %, ≤1 wt %, ≤0.9 wt %, ≤0.8 wt %, ≤0.7 wt %, ≤0.6 wt %, ≤0.5 wt %, ≤0.4 wt %, ≤0.3 wt %, ≤0.2 wt %, or ≤0.1 wt % of any wax having a melting point of >25° C., based on a total mass of the catalyst slurry, the catalyst solution, or the modified catalyst slurry.

In various embodiments, an aluminum alkyl, an ethoxylated aluminum alkyl, an alumoxane, an anti-static agent (such anti-static agents are referenced in Paragraphs [0078]-[0082] of WO2022/174202) or a borate activator, such as a C₁ to C₁₅ alkyl aluminum (for example tri-isobutyl aluminum, trimethyl aluminum or the like), a C₁ to C₁₅ ethoxylated alkyl aluminum or methyl aluminoxane, ethyl aluminoxane, isobutylaluminoxane, modified aluminoxane or the like can be added in-line to the modified catalyst slurry. For example, the alkyls, antistatic agents, borate activators and/or alumoxanes can be added from a vessel directly to the modified catalyst slurry in-line. The additional alkyls, antistatic agents, borate activators and/or alumoxanes can be present in an amount of 1 ppm, 10 ppm, 50 ppm, 75 ppm, or 100 ppm to 200 ppm, 300 ppm, 400 ppm, or 500 ppm. In some embodiments, an optional carrier fluid such as molecular nitrogen, argon, ethane, propane, and the like, can be added in-line to the modified catalyst slurry. The carrier fluid, e.g., molecular nitrogen, can be introduced through a line at a rate of (or, when multiple lines are used, at an average rate of) about 0.4 kg/hr, 1 kg/hr, 5 kg/hr, or 8 kg/hr to 11 kg/hr, 23 kg/hr, or 45 kg/hr per line. In other embodiments, the carrier fluid can be introduced through the line at a rate of or, when multiple lines are used, at an average rate of about 5 kg/hr, 7 kg/hr, 9 kg/hr, or 10 kg/hr to 11 kg/hr, 13 kg/hr, or 15 kg/hr per line.

In some embodiments (not directly shown in FIG. 1, 2, or 3), a carrier fluid, such as molecular nitrogen, monomers (including comonomers), or other materials can be introduced to the modified catalyst slurry after mixing the catalyst solution and the catalyst slurry. The introduction can take place along the line leading to the gas-phase polymerization reactor or in an injection nozzle, which can include a support tube that can at least partially surround an injection nozzle. The modified catalyst slurry can be passed through the injection nozzle into the reactor. In various embodiments, the injection nozzle can aerosolize the catalyst-containing mixture. Any number of suitable tubing sizes and configurations can be used to aerosolize and/or inject the slurry/solution mixture.

In some configurations, a carrier fluid may be split off or otherwise sourced, directly or indirectly, from cycle gas (e.g., all or a portion of the cycle gas). In this case, where cycle gas is used as a carrier fluid, the skilled artisan might appreciate that such cycle gas could also include induced condensing agent. The cycle gas may comprise at least a portion of a polymerization feed being recycled through the gas-phase polymerization reactor.

As noted, one or more monomers, such as ethylene, hexene, another alpha-olefin, a diolefin, or a mixture thereof, can be added in-line to the modified catalyst slurry prior to entering the polymerization reactor. Also or instead, the one or more monomers can be introduced into the reactor separate and apart from the modified catalyst slurry. In some examples, the one or more monomers may be introduced to a recycle gas circulating through the polymerization reactor.

In some embodiments, the modified catalyst slurry can include 1 wt %, 5 wt %, 10 wt %, or 15 wt % to 25 wt %, 30 wt %, 35 wt %, or 40 wt % of the one more catalyst compounds, based on a total weight of the modified catalyst slurry. The foregoing weight percentages do not include the support material upon which the catalyst is disposed. In such embodiments, a total amount of the modified catalyst slurry introduced into the reactor can be at a flow rate of ≥0.1 kg/hr per cubic meter of polymerization reactor volume, ≥0.11 kg/hr per cubic meter of polymerization reactor volume, ≥0.12 kg/hr per cubic meter of polymerization reactor volume, 0.13 kg/hr per cubic meter of polymerization reactor volume or ≥0.14 kg/hr per cubic meter of polymerization reactor volume to 0.2 kg/hr per cubic meter of polymerization reactor volume, 0.3 kg/hr per cubic meter of polymerization reactor volume, 0.4 kg/hr per cubic meter of polymerization reactor volume, or 0.5 kg/hr per cubic meter of polymerization reactor volume.

In some embodiments, to promote formation of particles in the reactor, an optional nucleating agent, such as silica, alumina, fumed silica or other suitable particulate matter can be added directly into the reactor. Alternatively, a nucleating agent may be present in the catalyst solution, the catalyst slurry, and/or the modified catalyst slurry, optionally with further introduction of nucleating agent to the reactor also taking place. Advantageously, nucleating agent may be optional in the disclosure herein, but may be included, if desired. Preferably, a nucleating agent is excluded from the catalyst solution and the catalyst slurry and/or when mixing the catalyst solution and the catalyst slurry (that is, nucleating agent, if any, is introduced into the modified catalyst slurry in line(s) downstream from any mixing unit. For embodiments that do not include a nucleating agent, it has been discovered that a high polymer bulk density (e.g., 0.4 g/cm³ or greater) can be obtained, which is greater than the bulk density of polymers formed by conventional trim processes. Furthermore, when a metallocene catalyst or other similar catalyst is used in the gas phase reactor, oxygen or fluorobenzene can be added to the reactor directly or to the gas stream (including carrier fluid) in-line to control the polymerization rate. Thus, when a metallocene catalyst (which is sensitive to oxygen or fluorobenzene) is used in combination with another catalyst (that is not sensitive to oxygen) in a gas phase reactor, oxygen can be used to modify the metallocene polymerization rate relative to the polymerization rate of the other catalyst. WO 1996/009328 discloses the addition of water or carbon dioxide to gas phase polymerization reactors, for example, for similar purposes.

### Catalyst Compounds

The methods of the present disclosure can be employed generally with any catalyst system including at least one catalyst compound localized on a support, preferably two or more catalyst compounds localized on a support once a modified supported catalyst has been formed. In particular examples, the supported catalyst in a catalyst slurry may contain a first catalyst compound on a support, and a second catalyst compound different from the first catalyst compound may be delivered from a catalyst solution to the catalyst slurry to form a modified catalyst slurry according to the disclosure herein.

As a particular example, the catalyst compounds can include one or more metallocenes. In some embodiments, the catalyst can include first and second catalyst compounds that are at least a first metallocene and a second metallocene, where the first and second metallocenes have different chemical structures from one another. Metallocenes can include structures having one or more Cp ligands (cyclopentadienyl and ligands isolobal to cyclopentadienyl) bound to at least one Group 3 to Group 12 metal atom, and one or more leaving group(s) bound to the at least one metal atom.

Suitable metallocene catalysts may include those described in US Patent Application Publications 2019/0119413 and 2019/0119417, which are incorporated herein by reference. Also suitable are catalyst systems employing a mix of two metallocene catalysts such as those described in US Patent Application Publication 2020/0071437, such as a mix of (1) a bis-cyclopentadienyl hafnocene and (2) a zirconocene, such as an indenyl-cyclopentadienyl zirconocene. Additional details are provided hereinafter.

More particularly, the bis-cyclopentadienyl hafnocene may be in accordance with one or more of the metallocenes according to formulas (A1) and/or (A2) as described in US2020/0071437; for instance, those per formula (A1) as described in Paragraphs [0069]-[0086] of US2020/0071437; or those per formula (A2) as described in Paragraphs [0086]-[0101] of US2020/0071437, which descriptions are incorporated herein by reference.

Particular examples of hafnocenes according to formula (A1) include bis(n-propylcyclopentadienyl)hafnium dichloride, bis(n-propylcyclopentadienyl)hafnium dimethyl, (n-propylcyclopentadienyl, pentamethylcyclopentadienyl)hafnium dichloride, (n-propylcyclopentadienyl, dimethyl, (n-pentamethylcyclopentadienyl)hafnium propylcyclopentadienyl, tetramethylcyclopentadienyl)hafnium dichloride, (n-propylcyclopentadienyl, tetramethylcyclopentadienyl)hafnium dimethyl, bis(cyclopentadienyl)hafnium dimethyl, bis(n-butylcyclopentadienyl)hafnium dichloride, bis(n-butylcyclopentadienyl)hafnium dimethyl, and bis(1-methyl-3-n-butylcyclopentadienyl)hafnium dimethyl.

Hafnocene compounds according to (A2) that are particularly useful include one or more of the compounds listed in Paragraph [0101] of US2020/0071437, also incorporated by reference herein, such as (for a relatively brief example): rac/meso Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₄Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; Me₂Si(Me₄Cp)(Me₂PhSiCH₂Cp)HfMe₂; etc.

Accordingly, in a particular example, the first catalyst compound upon the support material may comprise a first metallocene that is a hafnocene, such as a rac/meso dimethylsilylbis[((trimethylsilyl)methyl)cyclopentadienyl] hafnium dimethyl. The second catalyst compound in the catalyst solution may comprise a second metallocene that is different than the first metallocene. The second metallocene may comprise a zirconocene, as described hereinafter.

Suitable catalyst compounds may include a zirconocene, such as a zirconocene according to formula (B) as described in Paragraphs [0103]-[0113] of US2020/0071437, which description is also incorporated herein by reference, Particular examples of suitable zirconocenes may be any one or more of those listed in Paragraph [0112] of US2020/0071437, e.g.: bis (indenyl) zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl) zirconium dimethyl, meso-bis(1ethylindenyl) zirconium dichloride, meso-bis(1-ethylindenyl) zirconium dimethyl, (1-methylindenyl)(pentamethyl cyclopentadienyl) zirconium dichloride, (1-methylindenyl)(pentamethyl cyclopentadienyl) zirconium dimethyl, or combinations thereof.

Accordingly, in particular examples, the second catalyst compound may comprise a second metallocene that is a zirconocene, such as a rac/meso bis(1-methylindenyl) zirconium dimethyl.

As noted above, the supported catalyst and/or the modified supported catalyst can include one or more activators and/or supports in addition to one or more catalyst compounds. For example, this can include the abstraction of at least one leaving group from the metal center of the single site catalyst compound/component. The activator may also be referred to as a “co-catalyst.” For example, the supported catalyst or modified supported catalyst within the slurry catalyst or modified slurry catalyst mixture can include two or more activators (such as alumoxane and a modified alumoxane) and at least one catalyst compound, such as a first catalyst compound and a second catalyst compound. In particular embodiments, the slurry catalyst or modified slurry catalyst can include at least one support, at least one activator, and at least two catalyst compounds. For example, the slurry can include at least one support, at least one activator, and two different catalyst compounds that can be added separately or in combination to produce the slurry catalyst or modified slurry catalyst. In some embodiments, a mixture of a support, e.g., silica, and an activator, e.g., alumoxane, can be contacted with a catalyst compound, allowed to react, and thereafter the mixture can be contacted with another catalyst compound from a catalyst solution to form a modified supported catalyst within a modified catalyst slurry according to the disclosure herein.

The molar ratio of metal or non-coordinating anion in the activator to metal in the catalyst compound(s) in the slurry catalyst can be 1000:1 to 0.5:1, 300:1 to 1:1, 100:1 to 1:1, or 150:1 to 1:1. The support material for the supported catalyst can be any inert particulate carrier material known in the art, including, but not limited to, silica, fumed silica, alumina, clay, talc or other support materials such as disclosed above. In one embodiment, the supported catalyst can include silica and an activator, such as methyl alumoxane (“MAO”), modified methyl alumoxane (“MMAO”), or the like. Preferred activators typically include alumoxane compounds, modified alumoxane compounds, and ionizing anion precursor compounds that abstract a reactive, o-bound, metal ligand making the metal compound cationic and providing a charge-balancing non-coordinating or weakly coordinating anion. For instance, suitable activators may include any of the alumoxane activators and/or ionizing/non-coordinating anion activators described in Paragraphs [0118]-[0128] of US2020/0071437, also incorporated herein by reference.

Suitable supports include, but are not limited to, active and inactive materials, synthetic or naturally occurring zeolites, as well as inorganic materials such as clays and/or oxides such as silica, alumina, zirconia, titania, silica-alumina, cerium oxide, magnesium oxide, or combinations thereof. In particular, the support may be silica-alumina, alumina and/or a zeolite, particularly alumina. Silica-alumina may be either naturally occurring or in the form of gelatinous precipitates or gels including mixtures of silica and metal oxides. Suitable supports may include any of the support materials described in Paragraphs [0129]-[0131] of US2020/0071437, which description is also incorporated by reference herein; wherein Al₂O₃, ZrO₂, SiO₂ and combinations thereof are particularly noted.

### Catalyst Solution

The catalyst solution can include a solvent or diluent and only catalyst compound(s), such as a metallocene, or can also include an activator. The at least one catalyst compound in the catalyst solution may be unsupported in a particular example. Preferably, the catalyst solution can be prepared by dissolving the at least one catalyst compound and an optional activator in the solvent or diluent. In some embodiments, the diluent or solvent can be an alkane, such as a C₅ to C₃₀ alkane, or a C₅ to C₁₀ alkane. Cyclic alkanes such as cyclohexane and aromatic compounds such as toluene can also be used. Mineral oil can be also used as the diluent alternatively or in addition to other alkanes such as one or more C₅ to C₃₀ alkanes. The mineral oil in the catalyst solution, if used, can have the same properties as the mineral oil that can be used to make the catalyst slurry.

The diluent or solvent employed can be liquid under the conditions of polymerization and relatively inert. In one embodiment, the diluent utilized in the catalyst solution can be different from the diluent used in the catalyst slurry. In another embodiment, the solvent utilized in the catalyst solution can be the same as the diluent, i.e., the mineral oil(s) and any additional diluents used in the catalyst slurry. Hydrocarbon solvents may also function as induced condensing agents during the polymerization reaction in some cases.

If the catalyst solution includes both the catalyst and an activator, the ratio of metal or non-coordinating anion in the activator to metal in the catalyst in the catalyst solution can be 1000:1 to 0.5:1, 300:1 to 1:1, or 150:1 to 1:1. In various embodiments, the activator and catalyst can be present in the catalyst solution at up to about 90 wt %, at up to about 50 wt %, at up to about 20 wt %, such as at up to about 10 wt %, at up to about 5 wt %, at less than 1 wt %, or between 100 ppm and 1 wt %, based on the weight of the diluent, the activator, and the catalyst. The one or more activators in the catalyst solution, if used, can be the same or different as the one or more activators present in the catalyst slurry upon the supported catalyst.

### Polymerization Conditions and Polyolefin Product

Once a modified catalyst slurry has been produced according to the disclosure above, the modified catalyst slurry may be fed to a polymerization reaction in combination with an olefinic feed under suitable polymerization conditions to obtain a polyolefin. In non-limiting examples, the olefinic feed may comprise at least one α-olefin to afford a polyolefin homopolymer or copolymer.

Monomers useful herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer can include ethylene and one or more optional comonomers selected from C₃ to C₄₀ olefins, such as C₄ to C₂₀ olefins, such as C₆ to C₁₂ olefins. Suitable C₄ to C₄₀ olefin monomers can be linear, branched, or cyclic. The C₄ to C₄₀ cyclic olefins may be strained or unstrained, monocyclic or polycyclic, and may optionally include heteroatoms and/or one or more functional groups. In at least one embodiment, the monomer can include ethylene and an optional comonomer that can include one or more C₃ to C₄₀ olefins, such as C₄ to C₂₀ olefins, such as C₆ to C₁₂ olefins.

In some embodiments, the C₂ to C₄₀ alpha olefin monomer and optional comonomer(s) include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

In at least one embodiment, one or more dienes can be present in the polymer product at up to 10 wt %, such as at 0.00001 wt % to 1.0 wt %, such as 0.002 wt % to 0.5 wt %, such as 0.003 wt % to 0.2 wt %, based upon the total weight of the composition. In at least one embodiment 500 ppm or less of diene is added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, where at least two of the unsaturated bonds are readily incorporated into a polymer by either a stereospecific or a non-stereospecific catalyst(s). The diene monomers can be selected from alpha, omega-diene monomers (i.e., di-vinyl monomers). The diolefin monomers are linear di-vinyl monomers, such as those containing from 4 to 30 carbon atoms. Examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbomene, norbornadiene, ethylidene norbornene, divinylbenzene, dicyclopentadiene or higher ring containing diolefins with or without substituents at various ring positions.

The temperature within the reactor can be greater than 30° C., greater than 40° C., greater than 50° C., greater than 90° C., greater than 100° C., greater than 110° C., greater than 120° C., greater than 150° C., or higher. In general, the reactor can be operated at a suitable temperature taking into account the sintering temperature of the polymer product being produced within the reactor. Thus, the upper temperature limit in one embodiment can be the melting temperature of the polymer product produced within in the reactor. However, higher temperatures can result in narrower molecular weight distributions that may be further improved by the addition of a catalyst or other co-catalysts

In some embodiments, hydrogen gas can be used in the polymerization process to help control or otherwise adjust the final properties of the polyolefin, such as described in the Polypropylene Handbook, at pages 76-78 (Hanser Publishers, 1996). Using certain catalyst systems, increasing concentrations (partial pressures) of hydrogen can increase a flow index such as the melt index of the polyethylene polymer. The melt index can thus be influenced by the hydrogen concentration. The amount of hydrogen in the polymerization can be expressed as a mole ratio relative to the total polymerizable monomer, for example, ethylene, or a blend of ethylene and hexene or propylene.

The amount of hydrogen used in the polymerization process can be an amount necessary to achieve the desired melt index of the final polyolefin polymer. For example, the mole ratio of hydrogen to total monomer (H₂:monomer) can be 0.0001 or greater, 0.0005 or greater, or 0.001 or greater. Further, the mole ratio of hydrogen to total monomer (H₂:monomer) can be 10 or less, 5 or less, 3 or less, or 0.10 or less. A range for the mole ratio of hydrogen to monomer can include any combination of any upper mole ratio limit with any lower mole ratio limit described herein. The amount of hydrogen in the reactor at any time can range to up to 5,000 ppm, up to 4,000 ppm in another embodiment, up to 3,000 ppm, or from 50 ppm to 5,000 ppm, or from 50 ppm to 2,000 ppm in another embodiment. The amount of hydrogen in the reactor can be from 1 ppm, 50 ppm, or 100 ppm to 400 ppm, 800 ppm, 1,000 ppm, 1,500 ppm, or 2,000 ppm, based on weight. Further, the ratio of hydrogen to total monomer (H₂:monomer) can be 0.00001:1 to 2:1, 0.005:1 to 1.5:1, or 0.0001:1 to 1:1. The one or more reactor pressures in a gas-phase process (either single stage or two or more stages) can vary from 690 kPa, 1,379 kPa, or 1,724 kPa to 2,414 kPa, 2,759 kPa, or 3,448 kPa.

The reactor can be capable of producing greater than 10 kg per hour (kg/hr), greater than 455 kg/hr, greater than 4,540 kg/hr, greater than 11,300 kg/hr, greater than 15,900 kg/hr, greater than 22,700 kg/hr, or greater than 29,000 kg/hr to 45,500 kg/hr of polymer, 70,000 kg/hr, 100,000 kg/hr, or 150,000 kg/hr.

In some embodiments, the polymer product can have a melt index ratio (I_{21.6}/I_{2.16}) ranging from 10 to less than 300, or, in many embodiments, from 20 to 66. The melt index (I_{2.16}) can be measured according to ASTM D-1238-13, condition E (190° C., 2.16 kg), and also referred to as “I₂ (190° C./2.16 kg)”. The melt index (I_{21.6}) can be measured according to ASTM D-1238-13, condition F (190° C., 21.6 kg), and also referred to as “I_{21.6} (190° C./21.6 kg)”.

In some embodiments, the polymer product can have a density ranging from 0.89 g/cm³, 0.90 g/cm³, or 0.91 g/cm³ to 0.95 g/cm³, 0.96 g/cm³, or 0.97 g/cm³. Density can be determined in accordance with ASTM D-792-20. In some embodiments, the polymer product can have a bulk density of from 0.25 g/cm³ to 0.5 g/cm³. For example, the bulk density of the polymer can be from 0.30 g/cm³, 0.32 g/cm³, or 0.33 g/cm³ to 0.40 g/cm³, 0.44 g/cm³, or 0.48 g/cm³. The bulk density can be measured in accordance with ASTM D-1895-17 method B.

In some embodiments, the polymerization process can include contacting one or more olefin monomers with a modified catalyst slurry that can include mineral oil and supported catalyst. The one or more olefin monomers can be ethylene and/or propylene and the polymerization process can include heating the one or more olefin monomers and the catalyst system to 70° C. or more to form ethylene polymers, propylene polymers, or ethylene-propylene copolymers.

In at least one embodiment, the catalysts and processes disclosed herein can be capable of producing ethylene polymers having a weight average molecular weight (Mw) from 40,000 g/mol, 70,000 g/mol, 90,000 g/mol, or 100,000 g/mol to 200,000 g/mol, 300,000 g/mol, 600,000 g/mol, 1,000,000 g/mol, or 1,500,000 g/mol. The Mw can be determined using Gel Permeation Chromatography (GPC). For the GPC data, the differential refractive index (DRI) method is preferred for Mn, while light scattering (LS) is preferred for Mw and Mz. The GPC can be performed on a Waters 150C GPC instrument with DRI detectors. GPC Columns can be calibrated by running a series of narrow polystyrene standards. Molecular weights of polymers other than polystyrenes are conventionally calculated by using Mark Houwink coefficients for the polymer in question.

The ethylene polymers may have a melt index (MI) of 0.05 g/10 min or greater, 0.2 g/10 min or greater, such as 0.4 g/10 min or greater, 0.6 g/10 min or greater, 0.7 g/10 min or greater, 0.8 g/10 min or greater, 0.9 g/10 min or greater, 1.0 g/10 min or greater, 1.1 g/10 min or greater, or 1.2 g/10 min or greater. In some embodiments, upper limit of MI of the ethylene polymers may be any one of 2.5, 3.0, 3.5, 4.0, 4.5, 5.0, 5.5, 19, 25, 50, or 100 g/10 min.

“Catalyst productivity” is a measure of how many grams of polymer (P) are produced using a polymerization catalyst comprising W g of catalyst (cat), over a period of time of T hours; and can be expressed by the following formula: P/(T×W) and expressed in units of gPgcat⁻¹hr⁻¹. In at least one embodiment, the productivity of the catalysts disclosed herein can be at least 50 gPgcat⁻¹hr⁻¹ or more, such as 500 gPgcat⁻¹hr⁻¹ or more, such as 800 gPgcat⁻¹hr⁻¹ or more, such as 5,000 gPgcat⁻¹hr⁻¹ or more, such as 6,000 gPgcat⁻¹hr⁻¹ or more.

While gas-phase polymerization processes are described above, it should be understood that other polymerization processes, which are well-known in the art, can also be used to produce the polymer product. In some embodiments, any suspension, homogeneous, bulk, solution, slurry, and/or other gas phase polymerization process known in the art can be used. Such processes can be run in a batch, semi-batch, or continuous mode. A homogeneous polymerization process is defined to be a process where at least about 90 wt % of the product is soluble in the reaction medium. A bulk process is defined to be a process where monomer concentration in all feeds to the reactor is 70 volume % or more. Alternately, no solvent or diluent is present or added in the reaction medium, (except for the small amounts used as the carrier for the catalyst or other additives, or amounts typically found with the monomer; e.g., propane in propylene).

In some embodiments, the polymerization process can be a slurry polymerization process, preferably a continuous slurry loop polymerization reaction process A single slurry loop reactor can be used, or multiple reactors in parallel or series (although, to achieve a unimodal molecular weight distribution it can be preferable that either a single reactor is used, or that the same catalyst, feed, and reaction conditions are used in multiple reactors, e.g., in parallel, such that the polymer product is considered made in a single reactive step). As used herein, the term “slurry polymerization process” means a polymerization process in which a supported catalyst is used and monomers are polymerized on the supported catalyst particles within a liquid medium (comprising, e.g., inert diluent and unreacted polymerizable monomers), such that a two-phase composition including polymer solids and the liquid circulate within the polymerization reactor. Typically, a slurried tank or slurry loop reactor can be used; in particular embodiments herein, a slurry loop reactor is preferred In such processes the reaction diluent, dissolved monomer(s), and catalyst can be circulated in a loop reactor in which the pressure of the polymerization reaction is relatively high. The produced solid polymer is also circulated in the reactor. A slurry of polymer and the liquid medium may be collected in one or more settling legs of the slurry loop reactor from which the slurry is periodically discharged to a flash chamber where the mixture can be flashed to a comparatively low pressure; as an alternative to settling legs, in other examples, a single point discharge process can be used to move the slurry to the flash chamber. The flashing results in substantially complete removal of the liquid medium from the polymer, and the vaporized polymerization diluent (e.g., isobutane) can then be recompressed in order to condense the recovered diluent to a liquid form suitable for recycling as liquid diluent to the reactor.

Slurry polymerization processes can include those described in U.S. Pat. No. 6,204,344. Other non-limiting examples of slurry processes include continuous loop or stirred tank processes. Also, other examples of slurry processes include those described in U.S. Pat. No. 4,613,484. In still other embodiments, the polymerization process can be a multistage polymerization process where one reactor is operating in slurry phase that feeds into a reactor operating in a gas phase as described in U.S. Pat. No. 5,684,097.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present disclosure, the following examples of preferred or representative embodiments are given. In no way should the following examples be read to limit, or to define, the scope of the invention

### EXAMPLES

### Example 1

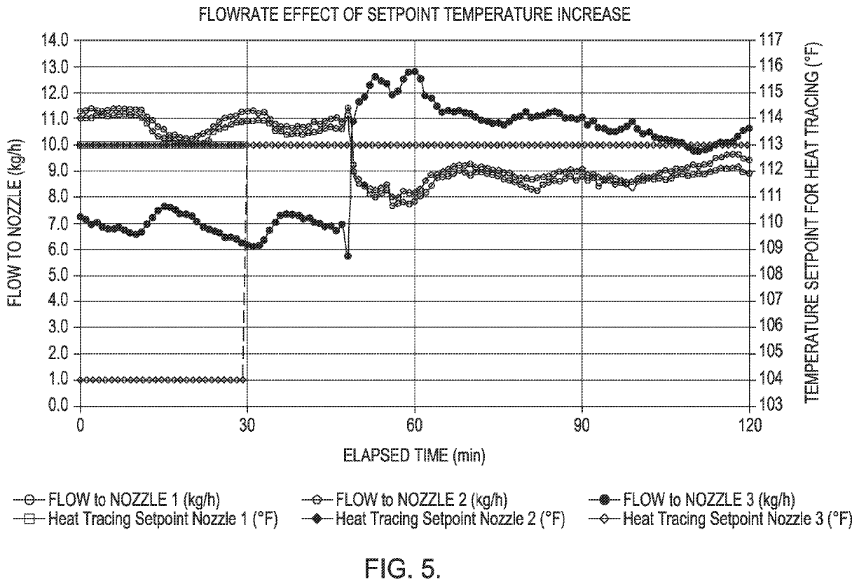

A sample quantity of modified catalyst slurry was heated using an electric heating unit. Its viscosity was measured at various sampling points (ASTM D445-21) and a curve plotted to visualize change in viscosity at varying temperatures, as well as a curve showing viscosity relative to viscosity at 40° C. The curves plotted are visible in FIG. 4. As shown, the viscosity of the modified catalyst slurry decreases with increased temperature (e.g., the viscosity at 45° C. is about 70% of the viscosity at 40° C.).

### Example 2

An exemplary system comprising 3 nozzles (Nozzles A, B, and C) with electric heat tracing was constructed. The setpoint of electric heat tracing on Nozzle C was altered from 104° F. to 113° F. Flow of all 3 nozzles was measured and plotted, as shown in FIG. 5. Following altering of setpoint as described, flowrate of Nozzle C moved closer to flowrates of Nozzles A and B.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A system comprising:
at least three injection nozzles fluidly connected to a gas-phase polymerization reactor, wherein the at least three injection nozzles are configured to carry a modified catalyst slurry;
at least three lines connected to the at least three injection nozzles, wherein the at least three lines comprise a first line connected to a first injection nozzle, a second line connected to a second injection nozzle, and a third line connected to a third injection nozzle; and
at least three slurry flow valves in contact with the at least three lines, wherein the at least three slurry flow valves comprise a first slurry flow valve, a second slurry flow valve, and a third slurry flow valve.

2. The system of claim 1, further comprising a control system configured to control each one of the first, second, and third slurry flow valves independently of the others.

3. The system of claim 1, wherein each of the first, second, and third lines comprises a heating block.

4. The system of claim 3, further comprising a control system configured to control the heating block of each of the first, second, and third lines independently of the heating block of the other lines, optionally wherein the control system is further configured to control each one of the first, second, and third slurry flow valves independently of the others.

5. The system of claim 1, wherein the modified catalyst slurry has a viscosity from 100 cP to 2000 cP, and the system has a range of operating temperature of the modified catalyst slurry from 20° C. to 80° C.

6. The system of claim 2, wherein the system is configured to be controlled such that residence time of the modified catalyst slurry carried in the first line is within 10% of the residence time of the modified catalyst slurry carried in each of the second and third lines; and optionally the system is further configured to be controlled such that one or both of the following is also true:
(a) flow rate of the modified catalyst slurry carried in the first line is within 10% of the flow rate of the modified catalyst slurry carried in each of the second and third lines; and
(b) temperature of the modified catalyst slurry carried in the first line is within 10% of the temperature of the modified catalyst slurry carried in each of the second and third lines.

7. The system of claim 2, wherein the system is configured to be controlled such that residence time of the modified catalyst slurry in the first line is greater than a first line residence time set-point; residence time of the modified catalyst slurry in the second line is greater than a second line residence time set-point; and residence time of the modified catalyst slurry in the third line is greater than a third line residence time set-point.

8. The system of claim 2, wherein the system is further configured to detect fouling in one of the first, second, and third lines; and further to either: (i) increase flow rate of the modified catalyst slurry in said one line in which fouling is detected; or (ii) decrease flow rate of the modified catalyst slurry in the other two lines in which fouling is not detected.

9. The system of claim 1, wherein the slurry flow valves are each pinch valves, or are each rotary globe valves.

10. A flow control method, the method comprising:
flowing a modified catalyst slurry into a gas-phase polymerization reactor through at least a first line connected to a first injection nozzle, a second line connected to a second injection nozzle, and a third line connected to a third injection nozzle,
wherein each of the first, second, and third injection nozzles are in fluid communication with the gas-phase polymerization reactor; and
independently regulating each of:
a) a first flow rate of the modified catalyst slurry in the first line by at least partially opening or closing a first slurry flow valve in contact with the first line,
b) a second flow rate of the modified catalyst slurry in the second line by at least partially opening or closing a second slurry flow valve in contact with the second line, or
c) a third flow rate of the modified catalyst slurry in the third line by at least partially opening or closing a third slurry flow valve in contact with the third line.

11. The method of claim 10, wherein the modified catalyst slurry has a viscosity from 100 cP to 2000 cP, and the temperature of the modified catalyst slurry remains within the range from 20° C. to 80° C.

12. The method of claim 10, wherein the regulating further comprises independently regulating each of:
(a) temperature of the first line by increasing or decreasing temperature of the first line using a first heating block;
(b) temperature of the second line by increasing or decreasing temperature of the second line using a second heating block; and
(c) temperature of the third line by increasing or decreasing temperature of the third line using a third heating block.

13. The method of claim 10, wherein the regulating is carried out such that the first flow rate, the second flow rate, and the third flow rate are within 10% of each other.

14. The method of claim 10, wherein the regulating is carried out such that the residence time of the modified catalyst slurry flowing through the first line is within 10% of the residence time of the modified catalyst slurry flowing through each of the second and third lines; and optionally the system is further configured to be controlled such that one or both of the following is also true:
(i) flow rate of the modified catalyst slurry flowing through the first line is within 10% of the flow rate of the modified catalyst slurry flowing through each of the second and third lines; and
(ii) temperature of the modified catalyst slurry flowing through the first line is within 10% of the temperature of the modified catalyst slurry flowing through each of the second and third lines.

15. The method of claim 10, wherein the regulating is carried out such that residence time of the modified catalyst slurry in the first line is greater than a first line residence time set-point; residence time of the modified catalyst slurry in the second line is greater than a second line residence time set-point; and residence time of the modified catalyst slurry in the third line is greater than a third line residence time set-point.

16. The method of claim 10, further comprising detecting fouling in one of the first, second, or third lines; and, in response to said detecting, adjusting the regulation of said one of the first, second, or third lines in which the fouling was detected.

17. The method of claim 10, wherein the slurry flow valves are each pinch valves, or are each rotary globe valves.

18. A method comprising:
obtaining a catalyst slurry comprising a supported catalyst, the supported catalyst comprising a support material, at least one catalyst compound, and at least one activator;
obtaining a catalyst solution comprising a first catalyst compound that is the same as the catalyst compound already contained upon the supported catalyst or a second catalyst compound different from the first catalyst compound and not already contained upon the supported catalyst;
contacting the catalyst slurry with the catalyst solution in a mixing unit to obtain a modified catalyst slurry from the mixing unit, the modified catalyst slurry comprising a modified supported catalyst incorporating at least a portion of the first catalyst compound or the second catalyst compound from the catalyst solution;
flowing the modified catalyst slurry into a gas-phase polymerization reactor through at least a first line connected to a first injection nozzle, a second line connected to a second injection nozzle, and a third line connected to a third injection nozzle,
wherein each of the first, second, and third injection nozzles are in fluid communication with the gas-phase polymerization reactor; and
independently regulating each of one or more of:
a) a first flow rate of the modified catalyst slurry in the first line by at least partially opening or closing a first slurry flow valve in contact with the first line,
b) a second flow rate of the modified catalyst slurry in the second line by at least partially opening or closing a second slurry flow valve in contact with the second line, or
c) a third flow rate of the modified catalyst slurry in the third line by at least partially opening or closing a third slurry flow valve in contact with the third line.

19. The method of claim 18, wherein the modified catalyst slurry has a viscosity from 100 cP to 2000 cP, and the temperature of the modified catalyst slurry remains within the range from 20° C. to 80° C.

20. The method of claim 18 or claim 19, wherein the regulating further comprises independently regulating each of:
(a) temperature of the first line by increasing or decreasing temperature of the first line using a first heating block;
(b) temperature of the second line by increasing or decreasing temperature of the second line using a second heating block; and
(c) temperature of the third line by increasing or decreasing temperature of the third line using a third heating block.

21. The method of claim 18, wherein the regulating is carried out such that the residence time of the modified catalyst slurry flowing through the first line is within 10% of the residence time of the modified catalyst slurry flowing through each of the second and third lines; and optionally the system is further configured to be controlled such that one or both of the following is also true:
(i) flow rate of the modified catalyst slurry flowing through the first line is within 10% of the flow rate of the modified catalyst slurry flowing through each of the second and third lines; and
(ii) temperature of the modified catalyst slurry flowing through the first line is within 10% of the temperature of the modified catalyst slurry flowing through each of the second and third lines.

22. The method of claim 18 wherein (1) the modified catalyst slurry flowed into the gas-phase polymerization reactor through the first line comprises a first amount of first catalyst compound deposited on the modified supported catalyst of said modified catalyst slurry and a first amount of second catalyst compound deposited on the modified supported catalyst of said modified catalyst slurry; (2) the modified catalyst slurry flowed into the gas-phase polymerization reactor through the second line comprises a second amount of first catalyst compound deposited on the modified supported catalyst of said modified catalyst slurry and a second amount of second catalyst compound deposited on the modified supported catalyst of said modified catalyst slurry; and (3) the modified catalyst slurry flowed into the gas-phase polymerization reactor through the third line comprises a third amount of first catalyst compound deposited on the modified supported catalyst of said modified catalyst slurry and a third amount of second catalyst compound deposited on the modified supported catalyst of said modified catalyst slurry; and further wherein the first, second, and third amounts are within 5 wt % of each other, said wt % on the basis of mass of catalyst compound divided by mass of modified supported catalyst.
